(19) United States
(12) Patent Application Publication
(10) Pub. No.: US 2026/0099191 A1
(43) Pub. Date: Apr. 9, 2026

(54) TRIGGER ACTIVATION MECHANISM IN TIME-EVOLVING SCENE DESCRIPTION

(71) Applicant: InterDigital CE Patent Holdings, SAS, Paris (FR)

(72) Inventors: Sylvain Lelievre, Montgermont (FR); Pierrick Jouet, Rennes (FR); Patrice Hirtzlin, Betton (FR); Etienne Faivre d'Arcier, Saint Gonlay (FR); Loic Fontaine, Noyal sur Vilaine (FR)

(21) Appl. No.: 19/112,565

(22) PCT Filed: Sep. 18, 2023
(86) PCT No.: PCT/EP2023/075608

§ 371 Date: Mar. 18, 2025

(30) Foreign Application Priority Data
Sep. 23, 2022 (EP) 22306405.6

(51) Int. Cl. G06F 3/01; G06T 19/00

(52) U.S. Cl. CPC G06F 3/011; G06T 19/00; G06T 2210/32; G06T 2210/61

(57) ABSTRACT

Some embodiments of a method may include obtaining scene description data for a 3D scene, wherein the scene description data may include: scene element information describing each of a plurality of scene elements in the scene, trigger information describing at least one trigger condition, action information describing an action to perform on one or more scene elements associated with the action, and behavior information, wherein the behavior information associates at least one of the trigger conditions with at least one of the actions; and in response to a determination that at least one of the trigger conditions has produced a result and that activate information indicates that the result fires the at least one trigger, performing the at least one action on at least a first node associated with the at least one action.

### CROSS-REFERENCE TO OTHER APPLICATIONS

This application claims priority of European Patent Application No. EP22306405.6, filed Sep. 23, 2022, which is incorporated herein by reference in its entirety.

The present application incorporates by reference in their entirety the following applications: European Patent Application No. EP22305024.6, entitled “METHODS AND DEVICES FOR INTERACTIVE RENDERING OF A TIME-EVOLVING EXTENDED REALITY SCENE” and filed Jan. 12, 2022 (“024 application”); International Application No. PCT/EP2023/065281, entitled “SYSTEMS AND METHODS FOR PROVIDING INTERACTIVITY WITH LIGHT SOURCES IN A SCENE DESCRIPTION” and filed Jun. 7, 2023 ('281 application); and European Patent Application No. EP22305880.1, entitled “SYSTEMS AND METHODS FOR PROVIDING INTERACTIVITY WITH LIGHT SOURCES IN A SCENE DESCRIPTION” and filed Jun. 16, 2022 (“'880 application”).

### BACKGROUND

The present section is intended to introduce the reader to various aspects of art, which may be related to various aspects of the present principles that are described and/or claimed below. This discussion is believed to be helpful in providing the reader with background information to facilitate a better understanding of the various aspects of the present principles. Accordingly, it should be understood that these statements are to be read in this light, and not as admissions of prior art.

Extended reality (XR) is a technology enabling interactive experiences where the real-world environment and/or a video content is enhanced by virtual content, which can be defined across multiple sensory modalities, including visual, auditory, haptic, etc. During runtime of the application, the virtual content (3D content or audio/video file for example) is rendered in real-time in a way which is consistent with the user context (environment, point of view, device, etc.). Scene graphs (such as the one proposed by Khronos/gITF and its extensions defined in MPEG Scene Description format or Apple/USDZ for instance) are a possible way to represent the content to be rendered. They combine a declarative description of the scene structure linking real-environment objects and virtual objects on one hand, and binary representations of the virtual content on the other hand. Although such scene description frameworks ensure that the timed media and the corresponding relevant virtual content are available at any time during the rendering of the application, there is no description of how a user can interact with the scene objects at runtime for immersive XR experiences.

There is a lack of an XR system that can take an XR scene description including metadata describing how a user can interact with the scene objects at runtime and how these interactions may be updated during runtime of the XR application.

### SUMMARY

Embodiments described herein include methods that are used in video encoding and decoding (collectively “coding”).

A first example method in accordance with some embodiments may include: obtaining scene description data for a 3D scene, wherein the scene description data may include: scene element information describing each of a plurality of scene elements in the scene, trigger information describing at least one trigger condition, action information describing at least one action to perform on one or more scene elements associated with the at least one action, and behavior information, wherein the behavior information may include: a trigger list of at least one trigger, an action list of at least the at least one action; trigger combination information, the trigger combination information indicating a combination of a first trigger condition corresponding to a first trigger of the trigger list with other trigger conditions corresponding to other triggers of the trigger list, and activate information, the activate information indicating when to perform the at least one action depending on a result of the trigger combination information; and in response to a logical determination that: (i) the combination of the first trigger condition corresponding to the first trigger of the trigger list with the other trigger conditions corresponding to the other triggers of the trigger list has produced the result and (ii) the activate information indicating that the result fires the first and other triggers, performing the at least one action on one or more scene elements associated with the at least one action.

For some embodiments of the first example method, the trigger list may include one trigger, and there are no other triggers of the trigger list, the trigger combination information may include a unary operator operating on the one trigger, and the activate information may indicate when to perform the unary operator on the one trigger.

For some embodiments of the first example method, the trigger list may include at least two triggers, the trigger combination information may indicate how the at least two trigger conditions are to be combined, and the activate information may indicate when to perform the at least one action depending on the result of the trigger combination information.

For some embodiments of the first example method, performing the first action may include performing the first action one or more times based on the activate information.

For some embodiments of the first example method, determining the combination of the trigger condition of the at least one trigger of the trigger list with trigger conditions of the other triggers of the trigger list may include performing a logical operation on at least one of the trigger conditions.

For some embodiments of the first example method, determining the combination of the trigger condition of the at least one trigger of the trigger list with trigger conditions of the other triggers of the trigger list may include performing a logical OR operation of at least two trigger conditions.

For some embodiments of the first example method, at least a first one of the trigger conditions is a visibility condition that is satisfied when a specified scene element is visible to a specified camera node.

For some embodiments of the first example method, at least a first one of the trigger conditions is a proximity condition that is satisfied when a distance from a user camera to a specified scene element is within specified bounds.

For some embodiments of the first example method, at least a first one of the trigger conditions is a user input condition that is satisfied when a specified user interaction is detected.

For some embodiments of the first example method, at least a first one of the trigger conditions is a timed condition that is satisfied during a specified time period.

For some embodiments of the first example method, at least a first one of the trigger conditions is a collider condition that is satisfied in response to detection of a collision between specified scene elements.

For some embodiments of the first example method, the action information may describe at least two actions, and the behavior information may include information indicating, for at least one behavior, an order in which at least two of the at least two actions are to be performed.

For some embodiments of the first example method, the action information may describe at least two actions, and the behavior information may include information indicating that at least two of the at least two actions are to be performed concurrently.

For some embodiments of the first example method, at least one of the scene elements in the scene is a virtual object.

Some embodiments of the first example method may further include rendering the 3D scene according to the scene description data as operated on by the first action.

For some embodiments of the first example method, the trigger information may include an array of two or more triggers in the 3D scene.

For some embodiments of the first example method, the action information may include an array of two or more actions in the 3D scene.

For some embodiments of the first example method, the behavior information may include an array of two or more behaviors in the 3D scene.

For some embodiments of the first example method, the scene description data may be provided in a JSON format.

For some embodiments of the first example method, the scene description data may be provided in a GLTF format.

A first example method/apparatus in accordance with some embodiments may include: a processor; and a non-transitory computer-readable medium storing instructions operative, when executed by the processor, to cause the apparatus to perform any one of methods shown above.

A second example method/apparatus in accordance with some embodiments may include: obtaining scene description data for a 3D scene, wherein the scene description data may include: scene element information describing each of a plurality of scene elements in the scene, trigger information describing at least one trigger condition, action information describing at least one action to perform on one or more scene elements associated with the at least one action, and behavior information, wherein the behavior information associates at least one of the trigger conditions with at least one of the actions; and in response to a logical determination that: (i) a combination of the at least one of the trigger conditions has been met and (ii) a first action of the at least one action is associated with the combination of the trigger conditions by the behavior information, performing the first action on at least a first node associated with the first action.

For some embodiments of the second example method, the logical determination may further include determining that a trigger associated with the at least one trigger condition is activated.

For some embodiments of the second example method, the logical determination may further include determining an activation status of a combination of the at least one trigger condition, and performing the first action may include performing the first action one or more times based on the activation status.

For some embodiments of the second example method, determining the combination of the at least one trigger condition may include performing a logical operation on the at least one of the trigger conditions.

For some embodiments of the second example method, determining the combination of the at least one trigger condition may include performing a logical OR operation on the at least two trigger conditions.

For some embodiments of the second example method, at least a first one of the at least one trigger condition is a visibility condition that is satisfied when a specified scene element is visible to a specified camera node.

For some embodiments of the second example method, at least a first one of the at least one trigger condition is a proximity condition that is satisfied when a distance from a user camera to a specified scene element is within specified bounds.

For some embodiments of the second example method, at least a first one of the at least one trigger condition is a user input condition that is satisfied when a specified user interaction is detected.

For some embodiments of the second example method, at least a first one of the at least one trigger condition is a timed condition that is satisfied during a specified time period.

For some embodiments of the second example method, at least a first one of the at least one trigger condition is a collider condition that is satisfied in response to detection of a collision between specified scene elements.

For some embodiments of the second example method, the behavior information may identify at least one behavior, the behavior information for each of the at least one behavior identifying a trigger associated with one of the at least one trigger condition and one of the at least one of action.

For some embodiments of the second example method, the action information may describe at least two actions, and the behavior information may include information indicating, for at least one behavior, an order in which at least two of the at least two actions are to be performed.

For some embodiments of the second example method, the action information may describe at least two actions, and the behavior information may include information indicating that at least two of the at least two actions are to be performed concurrently.

For some embodiments of the second example method, at least one of the scene elements in the scene is a virtual object.

Some embodiments of the second example method may further include rendering the 3D scene according to the scene description data as operated on by the first action.

For some embodiments of the second example method, the trigger information may include an array of two or more triggers in the 3D scene.

For some embodiments of the second example method, the action information may include an array of two or more actions in the 3D scene.

For some embodiments of the second example method, the behavior information may include an array of two or more behaviors in the 3D scene.

For some embodiments of the second example method, the scene description data may be provided in a JSON format.

For some embodiments of the second example method, the scene description data may be provided in a GLTF format.

A second example method/apparatus in accordance with some embodiments may include: a processor; and a non-transitory computer-readable medium storing instructions operative, when executed by the processor, to cause the apparatus to perform any one of the methods listed above.

A third example method, which is a method for rendering an extended reality scene relative to a user in a timed environment, in accordance with some embodiments may include: obtaining a description of the extended reality scene, the description may include: a scene tree linking nodes describing timed objects, virtual objects or relationships between objects; behaviors data items, a behavior data item may include: at least a trigger control parameter, a trigger control parameter being a description of conditions related to one or more triggers; an activate condition related to the trigger control parameter; at least an action, an action being a description of process to be performed by an extended reality engine on objects describes by nodes of the scene tree; and on condition that a logical combination of at least one of the triggers of the behavior data item is triggered and the activate condition related to the trigger control parameter of the behavior data item is met, applying actions of the behavior data item to associated objects.

For some embodiments of the third example method, the logical combination of at least one trigger may include a logical operation on at least one of the conditions related to the one or more triggers.

For some embodiments of the third example method, the logical combination of at least one triggers may include a logical OR operation of at least two conditions related to the one or more triggers.

A third example method/apparatus in accordance with some embodiments may include: a processor; and a non-transitory computer-readable medium storing instructions operative, when executed by the processor, to cause the apparatus to perform any one of the methods listed above.

A fourth example method, which is a method for updating, at runtime, a first description of an extended reality scene including behavior data items with a second description of an extended reality scene, in accordance with some embodiments may include, for each on-going behavior data item of the first description, if the on-going behavior data item is not applicable with the second description: processing an interrupt action if existing for the on-going application in the first description; stopping the on-going behavior; and applying the second description.

A fifth example apparatus, which is a device for rendering an extended reality scene relative to a user in a timed environment, in accordance with some embodiments may include a memory associated with a processor configured to: obtain a description of the extended reality scene, the description including: a scene tree linking nodes describing timed objects, virtual objects or relationships between objects; behaviors data items, a behavior data item may include: at least a trigger, a trigger being a description of conditions; a trigger being activated when its conditions are detected in the timed environment; and at least an action, an action being a description of process to be performed by an extended reality engine on objects describes by nodes of the scene tree; and on condition that triggers of a behavior data item are activated, apply actions of the behavior to associated objects.

For some embodiments of the fifth example apparatus, the processor is further configured to: when a description of the extended reality scene is obtained, attribute an activation status set to false to at least one trigger of the description; when the conditions of the at least one trigger are met for the first time, set the activation status of the trigger to true; and when the conditions of the at least one trigger are met, activate the trigger.

For some embodiments of the fifth example apparatus, the processor is further configured to, when the conditions of the at least one trigger are met, if the activation status of the trigger is set to true, activate the trigger only if the description of the trigger authorizes a second activation.

A sixth example apparatus, which a device for updating, at runtime, a first description of an extended reality scene including behavior data items with a second description of an extended reality scene, in accordance with some embodiments may include a memory associated with a processor configured to: for each on-going behavior data item of the first description, if the on-going behavior data item is not applicable with the second description: process an interrupt action if existing for the on-going application in the first description; stop the on-going behavior; and apply the second description.

A seventh example apparatus in accordance with some embodiments may include one or more processors configured to perform any one of the methods listed above.

An eighth example apparatus in accordance with some embodiments may include a computer-readable medium including instructions for causing one or more processors to perform any one of the methods listed above.

For some embodiments of the eighth example apparatus, the computer-readable medium is a non-transitory storage medium.

A tenth example apparatus in accordance with some embodiments may include a computer program product including instructions which, when the program is executed by one or more processors, causes the one or more processors to carry out any one of the methods listed above.

An eleventh example apparatus in accordance with some embodiments may include a signal including scene description data for a 3D scene, wherein the scene description data may include: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions.

A twelfth example method/apparatus in accordance with some embodiments may include a computer-readable medium including scene description data for a 3D scene, wherein the scene description data may include: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions.

In additional embodiments, encoder and decoder apparatus are provided to perform the methods described herein. An encoder or decoder apparatus may include a processor configured to perform the methods described herein. The apparatus may include a computer-readable medium (e.g. a non-transitory medium) storing instructions for performing the methods described herein. In some embodiments, a computer-readable medium (e.g. a non-transitory medium) stores a video encoded using any of the methods described herein.

One or more of the present embodiments also provide a computer readable storage medium having stored thereon instructions for performing bi-directional optical flow, encoding or decoding video data according to any of the methods described above. The present embodiments also provide a computer readable storage medium having stored thereon a bitstream generated according to the methods described above. The present embodiments also provide a method and apparatus for transmitting the bitstream generated according to the methods described above. The present embodiments also provide a computer program product including instructions for performing any of the methods described.

### BRIEF DESCRIPTION OF THE DRAWINGS

FIG. 1A is a schematic side view illustrating an example waveguide display that may be used with extended reality (XR) applications according to some embodiments.

FIG. 1B is a schematic side view illustrating an example alternative display type that may be used with extended reality applications according to some embodiments.

FIG. 1C is a schematic side view illustrating an example alternative display type that may be used with extended reality applications according to some embodiments.

FIG. 1D is a system diagram illustrating an example set of interfaces for a system according to some embodiments.

FIG. 1E is a system diagram illustrating an example set of interfaces for a scene description according to some embodiments.

FIG. 2 is a system diagram illustrating an example set of interfaces for an MPEG-I node hierarchy supporting elements of scene interactivity according to some embodiments.

FIG. 3 is a block diagram showing an example of logical relationships between trigger information (describing triggers 1 through n), action information (describing actions 1 through m), and behavior information (describing relationships between the triggers and actions) in which triggers and actions may refer to one or more nodes in a scene description, such as a hierarchical scene graph, according to some embodiments.

FIG. 4 is a schematic plan view illustrating example relationships of extended reality scene description objects according to some embodiments.

FIG. 5A is a data structure illustrating an example set of triggers of an extended reality scene description according to some embodiments.

FIG. 5B is a data structure illustrating an example set of actions of an extended reality scene description according to some embodiments.

FIG. 5C is a data structure illustrating an example set of behaviors of an extended reality scene description according to some embodiments.

FIG. 5D is a data structure illustrating an example set of complementary information of an extended reality scene description according to some embodiments.

FIG. 6 is a data syntax diagram illustrating an example syntax for a data stream encoding an extended reality (XR) scene description according to some embodiments.

FIG. 7 is a flowchart illustrating an example process according to some embodiments.

FIG. 8 is a flowchart illustrating an example process for activating a trigger or a combination of triggers according to some embodiments.

FIG. 9 is a flowchart illustrating an example process for rendering an extended reality scene for an updated trigger mechanism according to some embodiments.

FIG. 10 is a flowchart illustrating an example process for trigger activation in a time-evolving scene description according to some embodiments.

The entities, connections, arrangements, and the like that are depicted in—and described in connection with—the various figures are presented by way of example and not by way of limitation. As such, any and all statements or other indications as to what a particular figure “depicts,” what a particular element or entity in a particular figure “is” or “has,” and any and all similar statements—that may in isolation and out of context be read as absolute and therefore limiting—may only properly be read as being constructively preceded by a clause such as “In at least one embodiment, . . . ” For brevity and clarity of presentation, this implied leading clause is not repeated ad nauseum in the detailed description.

### DETAILED DESCRIPTION

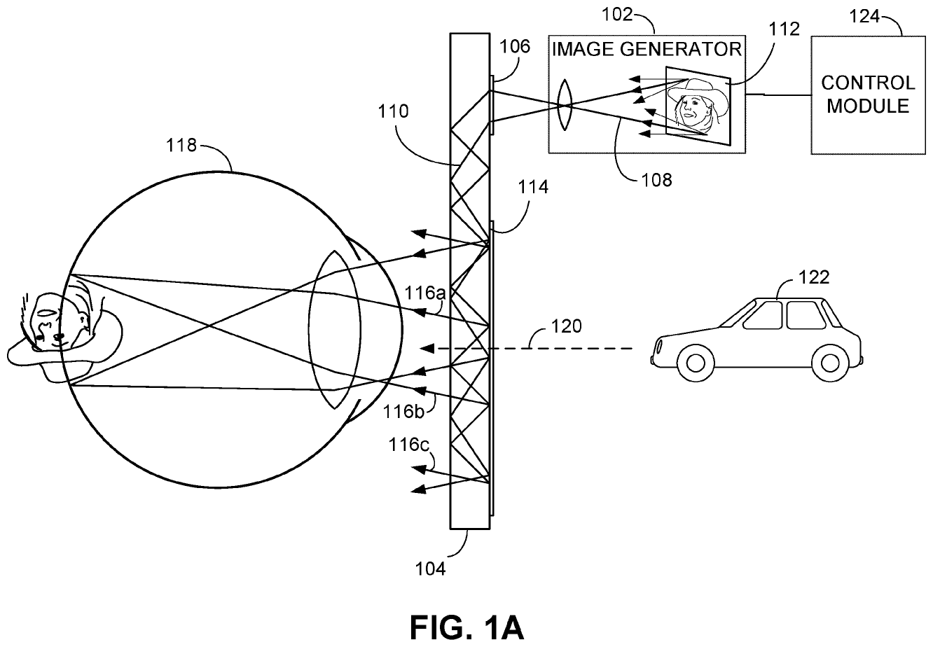

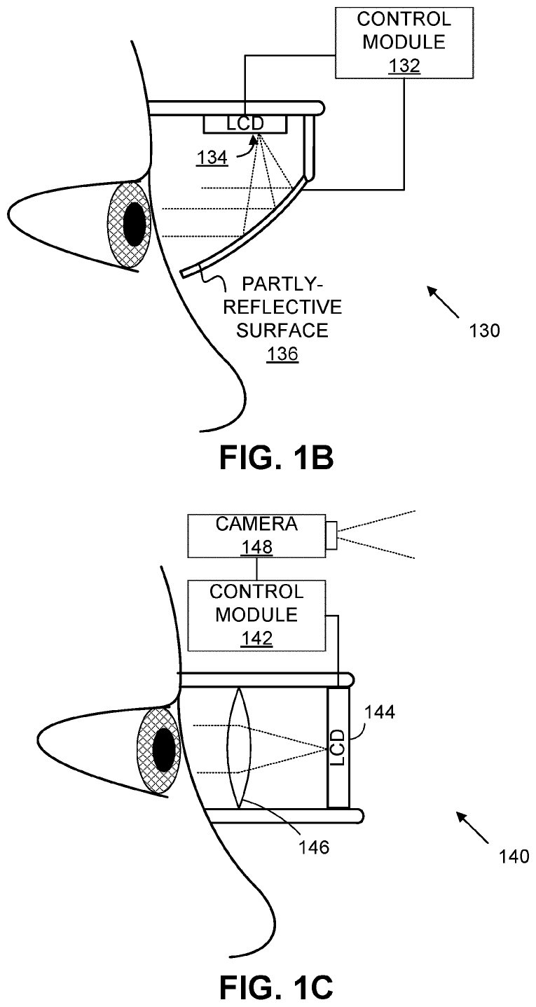

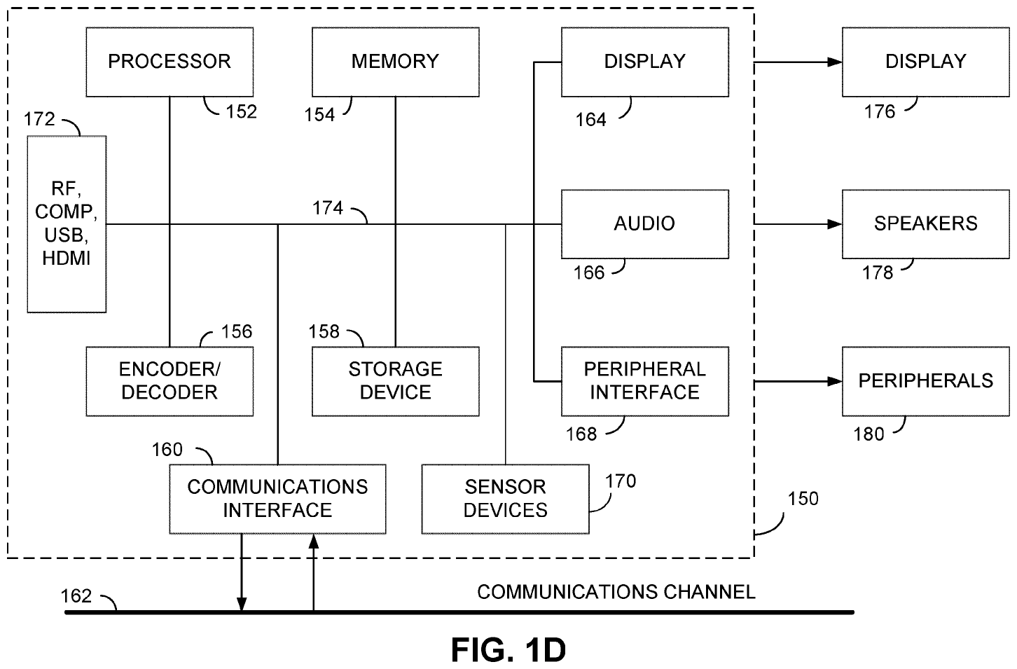

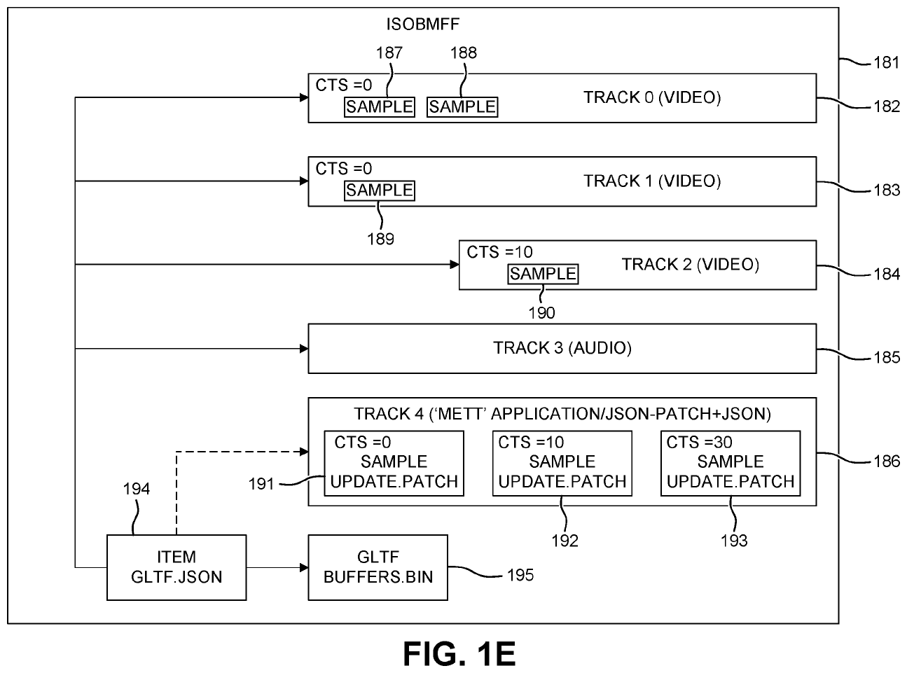

FIG. 1A is a schematic side view illustrating an example waveguide display that may be used with extended reality (XR) applications according to some embodiments. An image is projected by an image generator 102. The image generator 102 may use one or more of various techniques for projecting an image. For example, the image generator 102 may be a laser beam scanning (LBS) projector, a liquid crystal display (LCD), a light-emitting diode (LED) display (including an organic LED (OLED) or micro LED (μLED) display), a digital light processor (DLP), a liquid crystal on silicon (LCoS) display, or other type of image generator or light engine.

Light representing an image 112 generated by the image generator 102 is coupled into a waveguide 104 by a diffractive in-coupler 106. The in-coupler 106 diffracts the light representing the image 112 into one or more diffractive orders. For example, light ray 108, which is one of the light rays representing a portion of the bottom of the image, is diffracted by the in-coupler 106, and one of the diffracted orders 110 (e.g. the second order) is at an angle that is capable of being propagated through the waveguide 104 by total internal reflection. The image generator 102 displays images as directed by a control module 124, which operates to render image data, video data, point cloud data, or other displayable data.

At least a portion of the light 110 that has been coupled into the waveguide 104 by the diffractive in-coupler 106 is coupled out of the waveguide by a diffractive out-coupler 114. At least some of the light coupled out of the waveguide 104 replicates the incident angle of light coupled into the waveguide. For example, in the illustration, out-coupled light rays 116a, 116b, and 116c replicate the angle of the in-coupled light ray 108. Because light exiting the out-coupler replicates the directions of light that entered the in-coupler, the waveguide substantially replicates the original image 112. A user's eye 118 can focus on the replicated image.

In the example of FIG. 1A, the out-coupler 114 out-couples only a portion of the light with each reflection allowing a single input beam (such as beam 108) to generate multiple parallel output beams (such as beams 116a, 116b, and 116c). In this way, at least some of the light originating from each portion of the image is likely to reach the user's eye even if the eye is not perfectly aligned with the center of the out-coupler. For example, if the eye 118 were to move downward, beam 116c may enter the eye even if beams 116a and 116b do not, so the user can still perceive the bottom of the image 112 despite the shift in position. The out-coupler 114 thus operates in part as an exit pupil expander in the vertical direction. The waveguide may also include one or more additional exit pupil expanders (not shown in FIG. 1A) to expand the exit pupil in the horizontal direction.

In some embodiments, the waveguide 104 is at least partly transparent with respect to light originating outside the waveguide display. For example, at least some of the light 120 from real-world objects (such as object 122) traverses the waveguide 104, allowing the user to see the real-world objects while using the waveguide display. As light 120 from real-world objects also goes through the diffraction grating 114, there will be multiple diffraction orders and hence multiple images. To minimize the visibility of multiple images, it is desirable for the diffraction order zero (no deviation by 114) to have a great diffraction efficiency for light 120 and order zero, while higher diffraction orders are lower in energy. Thus, in addition to expanding and out-coupling the virtual image, the out-coupler 114 is preferably configured to let through the zero order of the real image. In such embodiments, images displayed by the waveguide display may appear to be superimposed on the real world.

FIG. 1B is a schematic side view illustrating an example alternative display type that may be used with extended reality applications according to some embodiments. In an XR head-mounted display device 130, a control module 132 controls a display 134, which may be an LCD, to display an image. The head-mounted display includes a partly-reflective surface 136 that reflects (and in some embodiments, both reflects and focuses) the image displayed on the LCD to make the image visible to the user. The partly-reflective surface 136 also allows the passage of at least some exterior light, permitting the user to see their surroundings.

FIG. 1C is a schematic side view illustrating an example alternative display type that may be used with extended reality applications according to some embodiments. In an XR head-mounted display device 140, a control module 142 controls a display 144, which may be an LCD, to display an image. The image is focused by one or more lenses of display optics 146 to make the image visible to the user. In the example of FIG. 1C, exterior light does not reach the user's eyes directly. However, in some such embodiments, an exterior camera 148 may be used to capture images of the exterior environment and display such images on the display 144 together with any virtual content that may also be displayed.

The embodiments described herein are not limited to any particular type or structure of XR display device.

FIG. 1D is a system diagram illustrating an example set of interfaces for a system according to some embodiments. An extended reality display device, together with its control electronics, may be implemented using a system such as the system of FIG. 1D. System 150 can be embodied as a device including the various components described below and is configured to perform one or more of the aspects described in this document. Examples of such devices, include, but are not limited to, various electronic devices such as personal computers, laptop computers, smartphones, tablet computers, digital multimedia set top boxes, digital television receivers, personal video recording systems, connected home appliances, and servers. Elements of system 150, singly or in combination, can be embodied in a single integrated circuit (IC), multiple ICs, and/or discrete components. For example, in at least one embodiment, the processing and encoder/decoder elements of system 150 are distributed across multiple ICs and/or discrete components. In various embodiments, the system 150 is communicatively coupled to one or more other systems, or other electronic devices, via, for example, a communications bus or through dedicated input and/or output ports. In various embodiments, the system 1000 is configured to implement one or more of the aspects described in this document.

The system 150 includes at least one processor 152 configured to execute instructions loaded therein for implementing, for example, the various aspects described in this document. Processor 152 may include embedded memory, input output interface, and various other circuitries as known in the art. The system 150 includes at least one memory 154 (e.g., a volatile memory device, and/or a non-volatile memory device). System 150 may include a storage device 158, which can include non-volatile memory and/or volatile memory, including, but not limited to, Electrically Erasable Programmable Read-Only Memory (EEPROM), Read-Only Memory (ROM), Programmable Read-Only Memory (PROM), Random Access Memory (RAM), Dynamic Random Access Memory (DRAM), Static Random Access Memory (SRAM), flash, magnetic disk drive, and/or optical disk drive. The storage device 158 can include an internal storage device, an attached storage device (including detachable and non-detachable storage devices), and/or a network accessible storage device, as non-limiting examples.

System 150 includes an encoder/decoder module 156 configured, for example, to process data to provide an encoded video or decoded video, and the encoder/decoder module 156 can include its own processor and memory. The encoder/decoder module 156 represents module(s) that can be included in a device to perform the encoding and/or decoding functions. As is known, a device can include one or both of the encoding and decoding modules. Additionally, encoder/decoder module 156 can be implemented as a separate element of system 150 or can be incorporated within processor 152 as a combination of hardware and software as known to those skilled in the art.

Program code to be loaded onto processor 152 or encoder/decoder 156 to perform the various aspects described in this document can be stored in storage device 158 and subsequently loaded onto memory 154 for execution by processor 152. In accordance with various embodiments, one or more of processor 152, memory 154, storage device 158, and encoder/decoder module 156 can store one or more of various items during the performance of the processes described in this document. Such stored items can include, but are not limited to, the input video, the decoded video or portions of the decoded video, the bitstream, matrices, variables, and intermediate or final results from the processing of equations, formulas, operations, and operational logic.

In some embodiments, memory inside of the processor 152 and/or the encoder/decoder module 156 is used to store instructions and to provide working memory for processing that is needed during encoding or decoding. In other embodiments, however, a memory external to the processing device (for example, the processing device can be either the processor 152 or the encoder/decoder module 152) is used for one or more of these functions. The external memory can be the memory 154 and/or the storage device 158, for example, a dynamic volatile memory and/or a non-volatile flash memory. In several embodiments, an external non-volatile flash memory is used to store the operating system of, for example, a television. In at least one embodiment, a fast external dynamic volatile memory such as a RAM is used as working memory for video coding and decoding operations, such as for MPEG-2 (MPEG refers to the Moving Picture Experts Group, MPEG-2 is also referred to as ISO/IEC 13818, and 13818-1 is also known as H.222, and 13818-2 is also known as H.262), HEVC (HEVC refers to High Efficiency Video Coding, also known as H.265 and MPEG-H Part 2), or VVC (Versatile Video Coding, a new standard being developed by JVET, the Joint Video Experts Team).

The input to the elements of system 150 can be provided through various input devices as indicated in block 172. Such input devices include, but are not limited to, (i) a radio frequency (RF) portion that receives an RF signal transmitted, for example, over the air by a broadcaster, (ii) a Component (COMP) input terminal (or a set of COMP input terminals), (iii) a Universal Serial Bus (USB) input terminal, and/or (iv) a High Definition Multimedia Interface (HDMI) input terminal. Other examples, not shown in FIG. 1C, include composite video.

In various embodiments, the input devices of block 172 have associated respective input processing elements as known in the art. For example, the RF portion can be associated with elements suitable for (i) selecting a desired frequency (also referred to as selecting a signal, or band-limiting a signal to a band of frequencies), (ii) downconverting the selected signal, (iii) band-limiting again to a narrower band of frequencies to select (for example) a signal frequency band which can be referred to as a channel in certain embodiments, (iv) demodulating the downconverted and band-limited signal, (v) performing error correction, and (vi) demultiplexing to select the desired stream of data packets. The RF portion of various embodiments includes one or more elements to perform these functions, for example, frequency selectors, signal selectors, band-limiters, channel selectors, filters, downconverters, demodulators, error correctors, and demultiplexers. The RF portion can include a tuner that performs various of these functions, including, for example, downconverting the received signal to a lower frequency (for example, an intermediate frequency or a near-baseband frequency) or to baseband. In one set-top box embodiment, the RF portion and its associated input processing element receives an RF signal transmitted over a wired (for example, cable) medium, and performs frequency selection by filtering, downconverting, and filtering again to a desired frequency band. Various embodiments rearrange the order of the above-described (and other) elements, remove some of these elements, and/or add other elements performing similar or different functions. Adding elements can include inserting elements in between existing elements, such as, for example, inserting amplifiers and an analog-to-digital converter. In various embodiments, the RF portion includes an antenna.

Additionally, the USB and/or HDMI terminals can include respective interface processors for connecting system 150 to other electronic devices across USB and/or HDMI connections. It is to be understood that various aspects of input processing, for example, Reed-Solomon error correction, can be implemented, for example, within a separate input processing IC or within processor 152 as necessary. Similarly, aspects of USB or HDMI interface processing can be implemented within separate interface ICs or within processor 152 as necessary. The demodulated, error corrected, and demultiplexed stream is provided to various processing elements, including, for example, processor 152, and encoder/decoder 156 operating in combination with the memory and storage elements to process the datastream as necessary for presentation on an output device.

Various elements of system 150 can be provided within an integrated housing, Within the integrated housing, the various elements can be interconnected and transmit data therebetween using suitable connection arrangement 174, for example, an internal bus as known in the art, including the Inter-IC (12C) bus, wiring, and printed circuit boards.

The system 150 includes communication interface 160 that enables communication with other devices via communication channel 162. The communication interface 160 can include, but is not limited to, a transceiver configured to transmit and to receive data over communication channel 162. The communication interface 160 can include, but is not limited to, a modem or network card and the communication channel 162 can be implemented, for example, within a wired and/or a wireless medium.

Data is streamed, or otherwise provided, to the system 150, in various embodiments, using a wireless network such as a Wi-Fi network, for example IEEE 802.11 (IEEE refers to the Institute of Electrical and Electronics Engineers). The Wi-Fi signal of these embodiments is received over the communications channel 162 and the communications interface 160 which are adapted for Wi-Fi communications. The communications channel 162 of these embodiments is typically connected to an access point or router that provides access to external networks including the Internet for allowing streaming applications and other over-the-top communications. Other embodiments provide streamed data to the system 150 using a set-top box that delivers the data over the HDMI connection of the input block 172. Still other embodiments provide streamed data to the system 150 using the RF connection of the input block 172. As indicated above, various embodiments provide data in a non-streaming manner. Additionally, various embodiments use wireless networks other than Wi-Fi, for example a cellular network or a Bluetooth network.

The system 150 can provide an output signal to various output devices, including a display 176, speakers 178, and other peripheral devices 180. The display 176 of various embodiments includes one or more of, for example, a touchscreen display, an organic light-emitting diode (OLED) display, a curved display, and/or a foldable display. The display 176 can be for a television, a tablet, a laptop, a cell phone (mobile phone), or other device. The display 176 can also be integrated with other components (for example, as in a smart phone), or separate (for example, an external monitor for a laptop). The other peripheral devices 180 include, in various examples of embodiments, one or more of a stand-alone digital video disc (or digital versatile disc) (DVR, for both terms), a disk player, a stereo system, and/or a lighting system. Various embodiments use one or more peripheral devices 180 that provide a function based on the output of the system 150. For example, a disk player performs the function of playing the output of the system 150.

In various embodiments, control signals are communicated between the system 150 and the display 176, speakers 178, or other peripheral devices 180 using signaling such as AV.Link, Consumer Electronics Control (CEC), or other communications protocols that enable device-to-device control with or without user intervention. The output devices can be communicatively coupled to system 1000 via dedicated connections through respective interfaces 164, 166, and 168. Alternatively, the output devices can be connected to system 150 using the communications channel 162 via the communications interface 160. The display 176 and speakers 178 can be integrated in a single unit with the other components of system 150 in an electronic device such as, for example, a television. In various embodiments, the display interface 164 includes a display driver, such as, for example, a timing controller (T Con) chip.

The display 176 and speaker 178 can alternatively be separate from one or more of the other components, for example, if the RF portion of input 172 is part of a separate set-top box. In various embodiments in which the display 176 and speakers 178 are external components, the output signal can be provided via dedicated output connections, including, for example, HDMI ports, USB ports, or COMP outputs.

The system 150 may include one or more sensor devices 168. Examples of sensor devices that may be used include one or more GPS sensors, gyroscopic sensors, accelerometers, light sensors, cameras, depth cameras, microphones, and/or magnetometers. Such sensors may be used to determine information such as user's position and orientation. Where the system 150 is used as the control module for an extended reality display (such as control modules 124, 132), the user's position and orientation may be used in determining how to render image data such that the user perceives the correct portion of a virtual object or virtual scene from the correct point of view. In the case of head-mounted display devices, the position and orientation of the device itself may be used to determine the position and orientation of the user for the purpose of rendering virtual content. In the case of other display devices, such as a phone, a tablet, a computer monitor, or a television, other inputs may be used to determine the position and orientation of the user for the purpose of rendering content. For example, a user may select and/or adjust a desired viewpoint and/or viewing direction with the use of a touch screen, keypad or keyboard, trackball, joystick, or other input. Where the display device has sensors such as accelerometers and/or gyroscopes, the viewpoint and orientation used for the purpose of rendering content may be selected and/or adjusted based on motion of the display device.

The embodiments can be carried out by computer software implemented by the processor 152 or by hardware, or by a combination of hardware and software. As a non-limiting example, the embodiments can be implemented by one or more integrated circuits. The memory 154 can be of any type appropriate to the technical environment and can be implemented using any appropriate data storage technology, such as optical memory devices, magnetic memory devices, semiconductor-based memory devices, fixed memory, and removable memory, as non-limiting examples. The processor 152 can be of any type appropriate to the technical environment, and can encompass one or more of microprocessors, general purpose computers, special purpose computers, and processors based on a multi-core architecture, as non-limiting examples.

### Scene Description Framework for XR

The present principles generally relate to the domain of rendering of extended reality scene description and extended reality rendering. The present document is also understood in the context of the formatting and the playing of extended reality applications when rendered on end-user devices such as mobile devices or Head-Mounted Displays (HMD).

In XR applications, a scene description is used to combine explicit and easy-to-parse description of a scene structure and some binary representations of media content.

In time-based media streaming, the scene description itself can be time-evolving to provide the relevant virtual content for each sequence of a media stream. For instance, for advertising purpose, a virtual bottle can be displayed during a video sequence where people are drinking.

This kind of behavior can be achieved by relying on the framework defined in the Scene Description for MPEG media document, Information technology-Coded representation of immersive media—Part14: Scene Description for MPEG media, ISO/IEC DIS 23090-14:2021 (E). A scene update mechanism based on the JSON Patch protocol as defined in IETF RFC 6902 may be used to synchronize virtual content to MPEG media streams.

FIG. 1E is a system diagram illustrating an example set of interfaces for a scene description according to some embodiments. In FIG. 1E, the scene description is stored as an item in gITF.json 194. The example scene description has three video tracks 182, 183, 184, an audio track 185, and a JSON patch update track 186 in an ISOBMFF file configuration 181 according to some embodiments. The example in FIG. 1E shows video samples 187, 188, 189, 190 within the video tracks 182, 183, 184 for an example configuration. The example JSON patch update track 186 has multiple sample update patches 191, 192, 193. The example ISOBMFF file configuration 181 shows a gltf buffers.bin 195 connected to the item gltf.json 194.

Although the MPEG-I Scene Description framework ensures that the timed media and the corresponding relevant virtual content are available at any time, it does not provide a description of how a user can interact with the scene objects at runtime for immersive XR experiences. Hence, there is no support of user specific XR experiences for consuming the immersive media.

Example embodiments as described herein may be used to provide a scene description that includes a virtual object or light source but that does not necessarily display or render the virtual object or light source even if available. In some embodiments, one or more of the following aspects may be considered in determining whether to display a virtual object or light source.

A spatial aspect may be considered in determining whether to display a virtual object or light source. For example, if the user environment is not suited (e.g. the user is too far from the rendered timed media's location) or if the user is not looking toward the right direction, or if the virtual object should be displayed on a user-specific area (e.g. above his left hand which is not yet detected), then the virtual object or light source may not be displayed.

A temporal aspect may be considered in determining whether to display a virtual object or light source. For example, if the user is not yet ready or wants to trigger himself the display of the object (e.g. using a specific gesture), the virtual object or light source may not be displayed until the appropriate trigger is detected.

In some embodiments, it is specified in the scene description which objects or light sources the user is allowed to manipulate or to interact with through potential haptic feedbacks.

### Runtime Interactivity

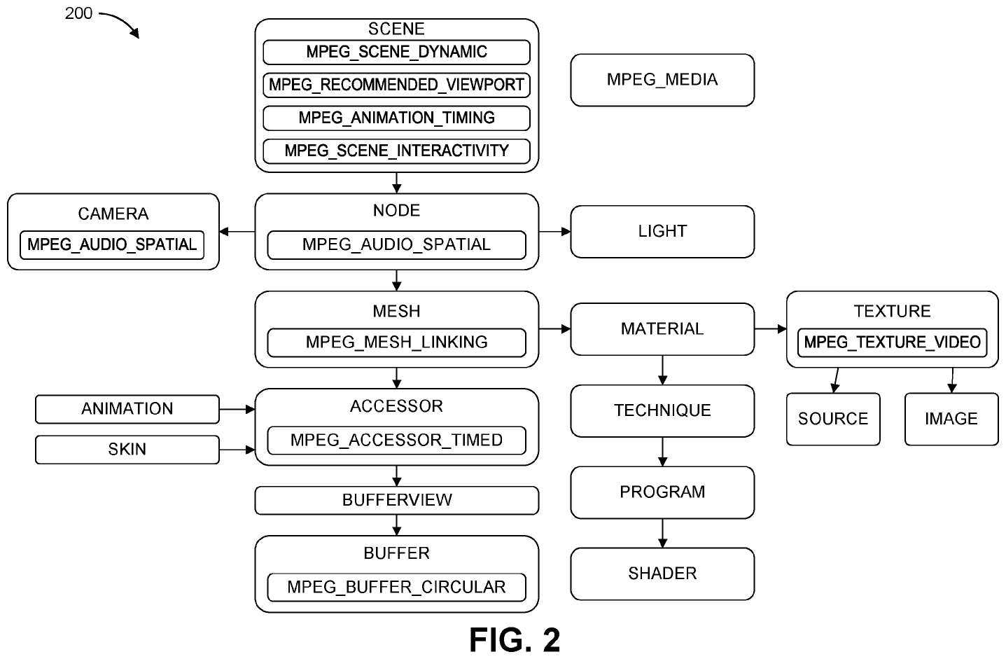

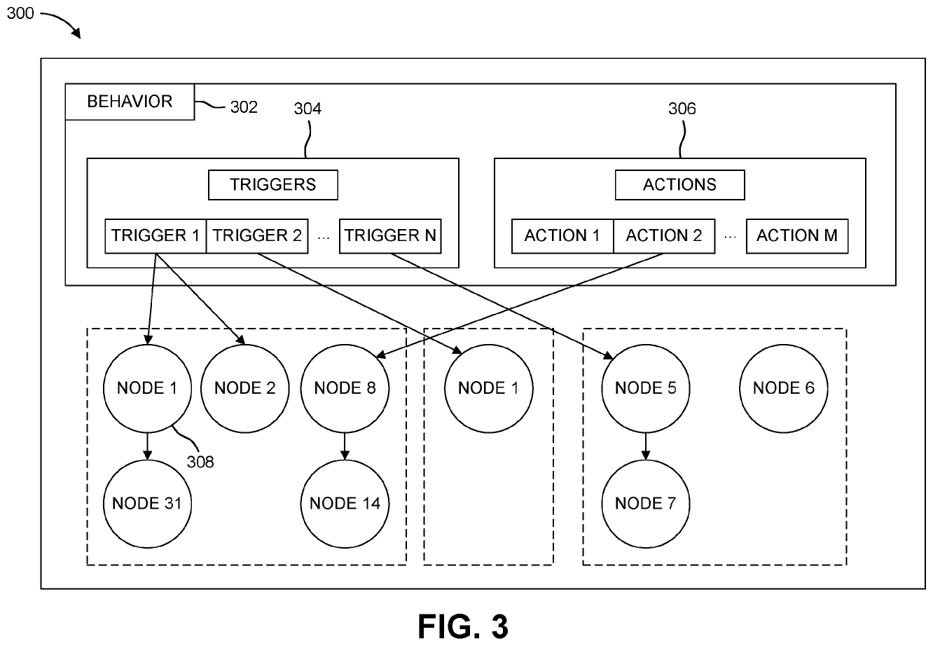

FIG. 2 is a system diagram illustrating an example set of interfaces for an MPEG-I node hierarchy supporting elements of scene interactivity according to some embodiments. FIG. 2 shows an example MPEG-I node hierarchy 200. According to the present principles, in addition to a node tree as described in relation to FIG. 3, behavior metadata items (herein called ‘behaviors’) are added to the scene description. In example embodiments, the time-evolving scene description is augmented by adding information identifying behaviors. These behaviors may be related to pre-defined virtual objects on which runtime interactivity is allowed for user specific XR experiences.

In some embodiments, these behaviors are time-evolving. In such embodiments, the behaviors may be updated through the already-existing scene description update mechanism.

In example embodiments, a behavior is characterized by one or more of the following properties:
One or more triggers defining the conditions to be met for activation.
A trigger control parameter defining the logical operations between the defined triggers.
Actions to be implemented in response to the activation of the triggers.
An action control parameter defining the order of execution of the defined actions.
A priority number enabling the selection of the behavior of highest priority in the case of concurrence of several behaviors on the same virtual object at the same time.
An optional interrupt action to specify how to terminate this behavior when the behavior is no longer defined in a newly received scene update. For instance, a behavior is no longer defined if the related object has been removed or if the behavior is no longer relevant for this current media (e.g. audio or video) sequence.

With the addition of these behaviors, time-dependent user interactivity in immersive content for XR experiences may be defined.

When a second scene description is received, some of the behaviors of the first scene description may be “on-going”, that is they are triggered, and their actions are running. The second scene description may be provided as update metadata, that is metadata describing the differences between the first scene description and the second description. The second scene description includes a node tree describing objects that may be common or different than objects of the first scene descriptions. Objects of the node tree of the first scene description may be no longer present in the second description. If the objects related to the running actions of the on-going behaviors are missing in the second scene description, then, these on-going behaviors are no longer applicable. The same way, if an on-going behavior is not defined in the second description, the on-going behavior is no longer applicable. The interrupt action field describes how to correctly interrupt the running actions on the on-going behavior.

FIG. 3 is a block diagram showing an example of logical relationships between trigger information (describing triggers 1 through n), action information (describing actions 1 through m), and behavior information (describing relationships between the triggers and actions) in which triggers and actions may refer to one or more nodes in a scene description, such as a hierarchical scene graph, according to some embodiments.

In XR applications, a scene description is used to combine explicit and easy-to-parse description of a scene structure and some binary representations of media content. The above sections describe action mechanisms for scene descriptions. These behaviors are related to pre-defined virtual objects on which runtime interactivity is allowed for user specific XR experiences. FIG. 3 illustrates the structure 300 of an example behavior mechanism. The example structure 300 of FIG. 3 shows an example triggers structure 304 and an example actions structure 306 within an example behavior structure 302. FIG. 3 also shows example nodes 308 with connections to particular example triggers and actions.

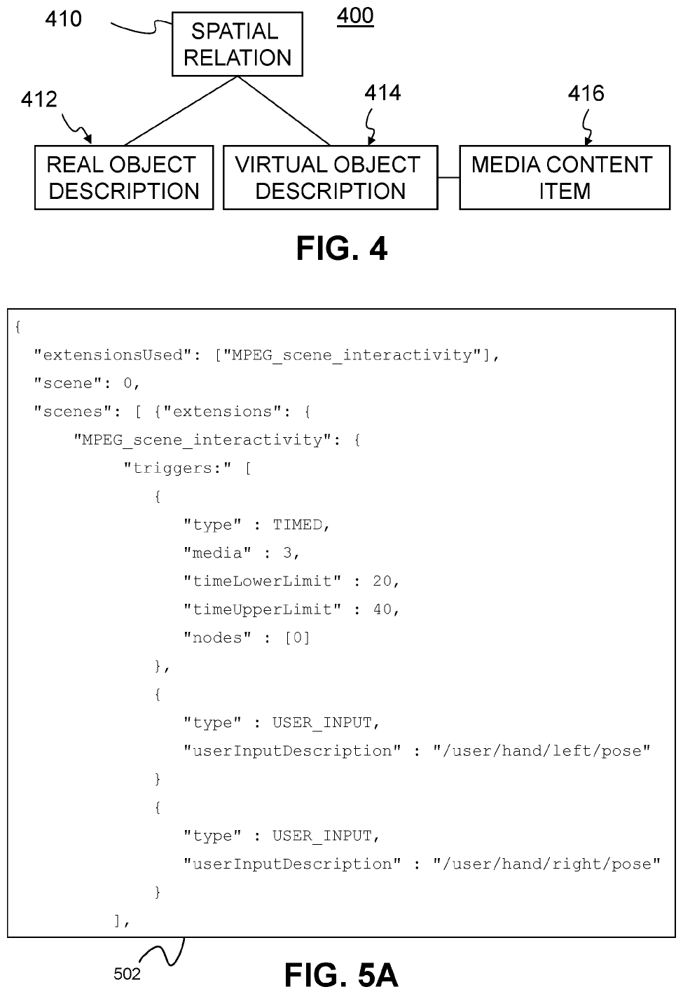

FIG. 4 is a schematic plan view illustrating example relationships of extended reality scene description objects according to some embodiments. In this example, the scene graph 400 includes a description of a real object 412, for example ‘plane horizontal surface’ (that can be a table or the floor or a plate) and a description of a virtual object 414, for example an animation of a walking character. Scene graph node 414 is associated with a media content item 416 that is the encoding of data used to render and display the walking character (for example as a textured animated 3D mesh). Scene graph 400 also includes a node 410 that is a description of the spatial relation between the real object described in node 412 and the virtual object described in node 414. In this example, node 410 describes a spatial relation to make the character walk on the plane surface. When the XR application is started, media content item 416 is loaded, rendered and buffered to be displayed when triggered. When a plane surface is detected in the real environment by sensors (or a camera for some embodiments), the application displays the buffered media content item as described in node 410. The timing is managed by the application according to features detected in the real environment and to the timing of the animation. A node of a scene graph may also include no description and only play a role of a parent for child nodes.

XR applications are various and may apply to different context and real or virtual environments. For example, in an industrial XR application, a virtual 3D content item (e.g. a piece A of an engine) is displayed when a reference object (piece B of an engine) is detected in the real environment by a camera rigged on a head mounted display device. The 3D content item is positioned in the real-world with a position and a scale defined relative to the detected reference object.

For example, in an XR application for interior design, a 3D model of a furniture is displayed when a given image from the catalog is detected in the input camera view. The 3D content is positioned in the real-world with a position and scale which is defined relative to the detected reference image. In another application, some audio file might start playing when the user enters an area which is close to a church (being real or virtually rendered in the extended real environment). In another example, an ad jingle file may be played when the user sees a can of a given soda in the real environment. In an outdoor gaming application, various virtual characters may appear, depending on the semantics of the scenery which is observed by the user. For example, birds characters are suitable for trees, so if the sensors of the XR device detect real objects described by a semantic label ‘tree’, birds can be added flying around the trees. In a companion application implemented by smart glasses, a car noise may be launched in the user's headset when a car is detected within the field of view of the user camera, in order to warn him of the potential danger; Furthermore, the sound may be spatialized in order to make it arrive from the direction where the car was detected.

An XR application may also augment a video content rather than a real environment. The video is displayed on a rendering device and virtual objects described in the node tree are overlaid when timed events are detected in the video. In such a context, the node tree includes only virtual objects descriptions.

Example embodiments are described with reference to the scope of the MPEG-I Scene Description framework using the Khronos gITF extension mechanism, which supports additional scene description features, such as a node tree. However, the principles described herein are not limited to a particular scene description framework.

In an example embodiment, the gITF scene description is extended to support interactivity. The interactivity extension applies at the gITF scene level and is called MPEG_scene_interactivity. The corresponding semantics are provided in Table 1.

TABLE 1
Semantics of an example MPEG_scene_interactivity extension

| Name | Type | Usage | Default | Description |
|---|---|---|---|---|
| triggers | array | M | [symbol] | Contains the definition of all the |
| | | | | triggers used in that scene |
| actions | array | M | [symbol] | Contains the definition of all the |
| | | | | actions used in that scene |
| behaviors | array | M | [symbol] | Contains the definition of all the |
| | | | | behaviors used in that scene. A |
| | | | | behavior is composed of a pair of |
| | | | | (triggers, actions), control |
| | | | | parameters of triggers and actions, |
| | | | | a priority weight and an optional |
| | | | | interrupt action |

In Table 1 and other semantic tables described herein, the “usage” column indicates “M” for “mandatory” features and “O” for “optional” features. However, such features may be “mandatory” or “optional” only according to a particular proposed syntax. A feature marked “mandatory” is not necessarily a required feature to implement the application. For example, in some embodiments, a feature marked “mandatory” is present to satisfy the expectations of a particular type of parsing and rendering software; however, in other embodiments, that feature may be optional, or the feature may be omitted entirely, with the corresponding functionality being implemented using default values or not being implemented at all without departing from the scope of the present disclosure.

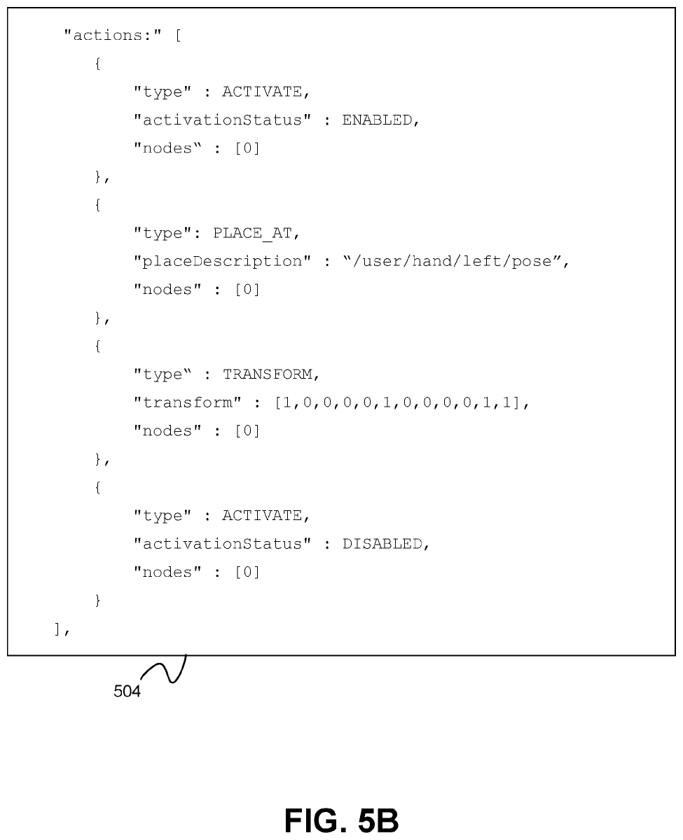

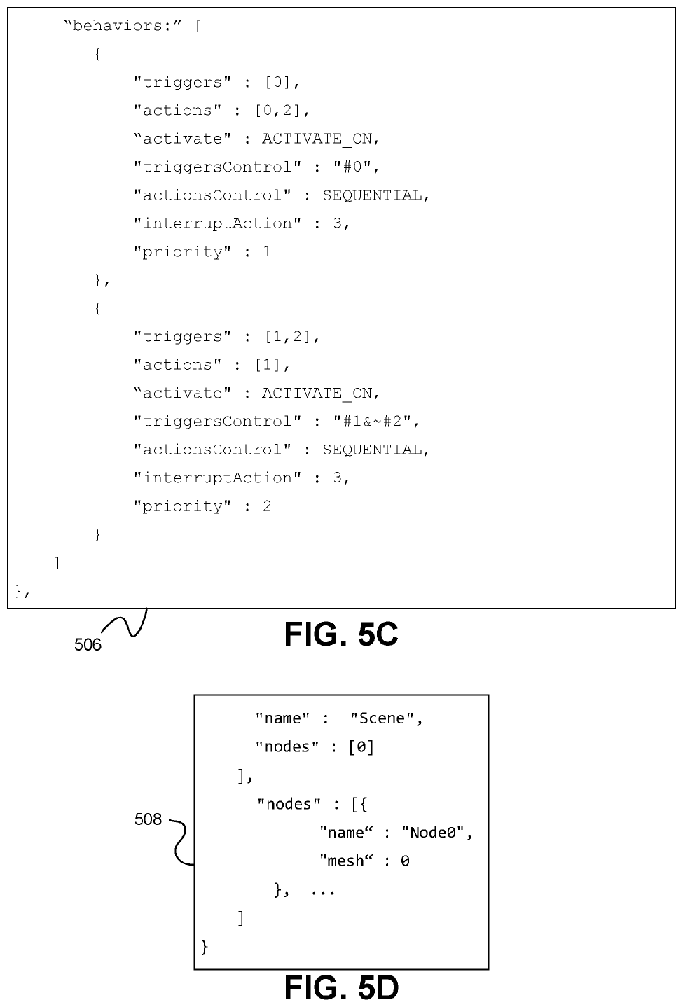

FIGS. 5A to 5D show non-limitative examples of an extended reality scene description according to the some embodiments.

In a first example presented in FIGS. 5A to 5D, a virtual 3D object is continuously displayed and transformed during a media sequence. Once the user's left hand is detected, the virtual 3D object is placed on the user's left hand and continuously follows it.

As an example of an interactive virtual object according to some embodiments, a virtual 3D advertisement object may be continuously displayed and transformed during a defined period (e.g., between 20 seconds and 40 seconds) in an MPEG media sequence between. In this example, once the user's left hand is detected, the virtual 3D object is placed on the user left hand and the virtual 3D object continuously follows the user's hand.

In this example, two behaviors are defined to support this interactivity scenario. The first behavior has the following parameters:
A first trigger related to a time sequence of a MPEG media between 20 seconds and 40 seconds with activation as long as conditions are met (ACTIVATE_ON).
Two sequential actions to enable and transform the virtual 3D object (node 0).
   The second behavior has the following parameters:
A trigger combination with a second trigger related to detection of the user's left hand and a third trigger related to no detection of the user's right hand with activation as long as conditions are met (ACTIVATE_ON).
A single action to place the virtual object (node 0) on the user's left hand.

The two behaviors define the same interrupt action which disables the virtual object (node 0). As the two behaviors affect the same virtual object (node 0), a higher priority is set to the second behavior related to the user gesture (pose of the left hand) to perform the desired interactivity scenario. In this example, the desired behaviors may be implemented using scene interactivity information, which may be provided in a JSON format, such as the example shown in FIGS. 5A to 5D.

For some embodiments, the Scene Description for MPEG media may be used to combine a scene structure with binary representations of media content. See “Information Technology—Coded Representation of Immersive Media—Part 14: Scene Description for MPEG Media,” ISO/IEC DIS 23090-14:2021 (E).

Although the MPEG-I Scene Description framework ensures that the timed media and the corresponding relevant virtual content are available at any time, there is no description of how a user interacts with the scene objects at runtime for immersive XR experiences. European Patent Application No. EP22305024 (filed Jan. 12, 2022) (“'024”) discusses augmenting the time-evolving scene description by adding behaviors. These behaviors are related to pre-defined virtual objects on which runtime interactivity is allowed for user specific XR experiences.

A behavior is composed of a set of triggers defining the conditions to be met for activation and a set of actions to be proceeded when the triggers are activated. Triggers control how parameters are defined to allow logical operation between triggers and activation policies.

Concerning the activation policies, a single Boolean flag (ActivateOnce) is specified for each trigger and indicates if the trigger is activated (i) each time the condition is met or (ii) only once after the condition is met. Table 2 provides an example syntax for triggers configured in this manner.

Such an activation mechanism may not be well suited when multiple triggers are referenced by the behavior's set of triggers: Depending on how those triggers are combined through logical operations (e.g., AND, OR, NOT, or other logical operators), activation flags may not be coherent among all the triggers for the following combination: a proximity trigger combined (logically ANDed) with a visibility trigger, in which both ActivateOnce flags are set to true. The combination of triggers may never occur. In one scenario, the visibility trigger may be activated only once and no longer when the proximity trigger will be activated. For example, the initial visibility trigger may be activated only once and no longer activated even when the proximity trigger is later activated multiple times.

The combination of triggers may be a combination of each condition rather than each trigger's activation status. Furthermore, the activation flag, as defined in application '024, may not allow for, e.g., additional cases that may occur, such as:
Activation of the trigger when the condition is no longer met.
Activation of the trigger only n times during the entire timeline of the scene or once each time the condition is met (or not met). The value of n may range from 1 to infinity.

This application, in accordance with some embodiments, defines a new Activate flag at the behavior level rather than the trigger level. This flag specifies the activation mechanism for the combination of triggers by defining several scenarios to activate the triggers. The condition of each referenced trigger is evaluated and combined following the triggers control parameters. This control parameter allows describing combination of logical operation between referenced triggers. It may be a string that describes this combination. The result of this evaluation (met or not met) and the Activate flag tells the presentation engine when to execute the actions of that behavior. The application introduces new data in a behavior-based interactive scene description. These data fields are used by a runtime processing model to control the behavior.

The application is detailed in the scope of the MPEG-I Scene Description framework using the Khronos gITF extension mechanism (“Khronos Group”) to support additional scene description features. This application modifies the MPEG_scene_interactivity gltf extensions defined in application '024.

This modification impacts the definition of triggers (in Tables 2 and 3) and behaviors (in Tables 5 and 6):
Removal of the ActivateOnce trigger's parameter
New Activate behavior parameter.
Modification of the triggersControl parameter so that multiple operations (e.g., AND, OR, NOT, or other operators) can be used for one combination of triggers. It may be a string combining the trigger index in the triggers array and logical operations. For example:
   A ‘#’ tag to indicate the trigger index, ‘&’ to indicate a logical AND operation, ‘|’ for a logical OR operation and ‘˜’ for a NOT operation, and parenthesis to group some operations. Such a syntax may give the following string:
      “#1&˜ #2|(#3& #4)”.
The default empty string may be understood as a logical OR between all the triggers.

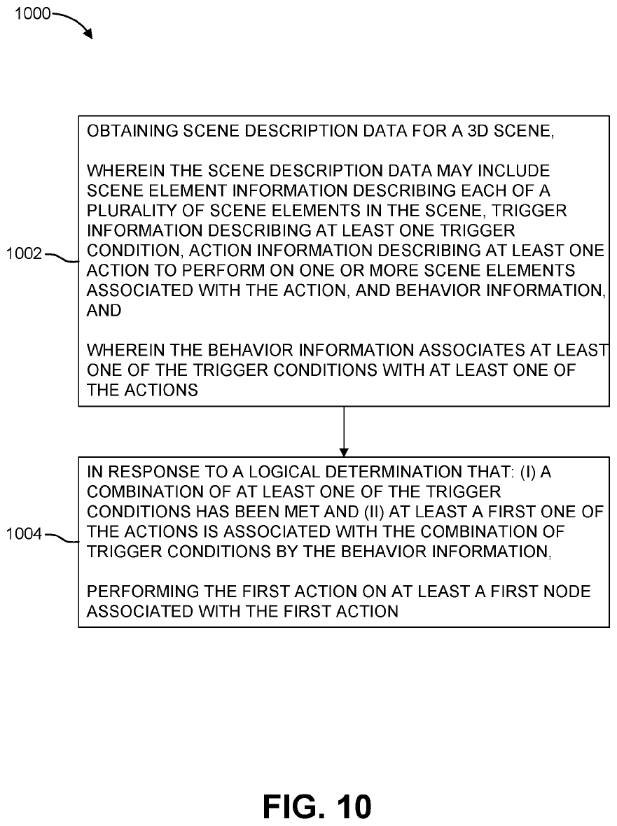

An example process for activating a trigger or a combination of triggers according to some embodiments is shown in FIG. 10 and further discuss below.

The parameters of an example trigger structure are shown in Table 2. Table 2 shows an activateOnce Boolean that indicates how often to activate a trigger when its conditions are met. This Boolean is removed in Table 3.

TABLE 2
First example trigger semantic

| Name | Type | Usage | Default | Description |
|---|---|---|---|---|
| type | enum | M | VISIBILITY | Defines the type of the trigger by |
| | | | | taking one of the following values: |
| | | | | VISIBILITY = 0, |
| | | | | PROXIMITY = 1, |
| | | | | USER_INPUT = 2, |
| | | | | TIMED = 3, |
| | | | | COLLIDER = 4 |
| activateOnce | boolean | M | FALSE | If FALSE: the trigger is activated |
| | | | | each time its conditions are met. |
| | | | | If TRUE: the trigger is activated |
| | | | | once when its conditions are met. |
| If (type == VISIBILITY){ | | | | |
| cameraNode | number | M | | Index to the node containing a |
| | | | | camera in the nodes array for |
| | | | | which the visibilities are determined |
| nodes | array | M | | Indices of the nodes in the nodes |
| | | | | array to be considered. All the |
| | | | | nodes shall be visible by the |
| | | | | camera to activate the trigger |
| } | | | | |
| If (type == PROXIMITY){ | | | | |
| distanceLowerLimit | number | M | 0 | Threshold min in meters for the |
| | | | | node proximity calculation |
| distanceUpperLimit | number | O | | Threshold max in meters for the |
| | | | | node proximity calculation |
| nodes | array | | | Indices of the nodes in the nodes |
| | | | | array to be considered. All the |
| | | | | nodes shall have a distance from |
| | | | | the user camera above the |
| | | | | distanceLowerLimit and below the |
| | | | | distanceUpperLimit to activate the |
| | | | | trigger |
| } | | | | |
| If (type == USER_INPUT){ | | | | |
| userInputDescription | string | M | | Describe the user body part and |
| | | | | gesture related to the input (e.g., |
| | | | | “/user/hand/left/grip” as specified in |
| | | | | OpenXR for the interaction profile |
| | | | | path; see KHRONOSGROUP, |
| | | | | github<dot>com/KhronosGroup/gITF/ |
| | | | | tree/main/extension, last visited |
| | | | | Sep. 20, 2022)(“Khronos Group”). |
| | | | | Other representations may be used |
| | | | | as an array of vertices (geometric |
| | | | | model) and a binary mask (body |
| | | | | part mask) used to specify where |
| | | | | haptic effects are applied. |
| nodes | array | O | | Indices of the nodes in the nodes |
| | | | | array to be considered for this user |
| | | | | input |
| } | | | | |
| If (type == TIMED){ | | | | |
| media | number | M | 0 | Index of the media in the MPEG |
| | | | | media array used to retrieve the |
| | | | | incremented media timeline. The |
| | | | | incremented time shall be higher |
| | | | | than the timeLowerLimit and below |
| | | | | the timeUpperLimit to activate the |
| | | | | trigger |
| timeLowerLimit | number | M | 0 | Threshold min in second |
| timeUpperLimit | number | O | | Threshold max in second |
| } | | | | |
| If (type == COLLIDER){ | | | | |
| nodes | array | M | | Indices of the nodes in the nodes |
| | | | | array to be considered for collision |
| | | | | determination. Any detection of |
| | | | | collision shall activate the trigger |
| } | | | | |

In some embodiments, instead of using a string parameter related to the Khronos OpenXR interaction profile paths syntax to define the user body part and gesture for the USER_INPUT trigger, other syntax formats may be used, such as a syntax format used for representation of haptic objects, where an array of vertices (geometric model) and a binary mask (body part mask) are used to specify where the haptic effect should be applied.

An updated trigger structure, according to some embodiments, is shown in Table 3. Table 3 removes the activateOnce Boolean that is shown in Table 2. The updated example trigger structure described below in Table 3 corresponds to FIG. 5A.

TABLE 3
Second example trigger semantic

| Name | Type | Usage | Default | Description |
|---|---|---|---|---|
| type | enum | M | VISIBILITY | Defines the type of the trigger by |
| | | | | taking one of the following values: |
| | | | | VISIBILITY = 0, |
| | | | | PROXIMITY = 1, |
| | | | | USER_INPUT = 2, |
| | | | | TIMED = 3, |
| | | | | COLLIDER = 4 |
| If (type == VISIBILITY){ | | | | |
| cameraNode | number | M | | Index to the node containing a |
| | | | | camera in the nodes array for |
| | | | | which the visibilities are determined |
| nodes | array | M | | Indices of the nodes in the nodes |
| | | | | array to be considered. All the |
| | | | | nodes shall be visible by the |
| | | | | camera to activate the trigger |
| } | | | | |
| If (type == PROXIMITY){ | | | | |
| distanceLowerLimit | number | M | 0 | Threshold min in meters for the |
| | | | | node proximity calculation |
| distanceUpperLimit | number | O | | Threshold max in meters for the |
| | | | | node proximity calculation |
| nodes | array | | | Indices of the nodes in the nodes |
| | | | | array to be considered. All the |
| | | | | nodes shall have a distance from |
| | | | | the user camera above the |
| | | | | distanceLowerLimit and below the |
| | | | | distanceUpperLimit to activate the |
| | | | | trigger |
| } | | | | |
| If (type == USER_INPUT){ | | | | |
| userInputDescription | string | M | | Describe the user body part and |
| | | | | gesture related to the input (e.g., |
| | | | | “/user/hand/left/grip” as specified in |
| | | | | OpenXR for the interaction profile |
| | | | | path; see KHRONOSGROUP, |
| | | | | github<dot>com/KhronosGroup/gITF/ |
| | | | | tree/main/extension, last visited |
| | | | | Sep. 20, 2022)(“Khronos Group”). |
| | | | | Other representations may be used |
| | | | | as an array of vertices (geometric |
| | | | | model) and a binary mask (body |
| | | | | part mask) used to specify where |
| | | | | haptic effects are applied. |
| nodes | array | O | | Indices of the nodes in the nodes |
| | | | | array to be considered for this user |
| | | | | input |
| } | | | | |
| If (type == TIMED){ | | | | |
| media | number | M | 0 | Index of the media in the MPEG |
| | | | | media array used to retrieve the |
| | | | | incremented media timeline. The |
| | | | | incremented time shall be higher |
| | | | | than the timeLowerLimit and below |
| | | | | the timeUpperLimit to activate the |
| | | | | trigger |
| timeLowerLimit | number | M | 0 | Threshold min in second |
| timeUpperLimit | number | O | | Threshold max in second |
| } | | | | |
| If (type == COLLIDER){ | | | | |
| nodes | array | M | | Indices of the nodes in the nodes |
| | | | | array to be considered for collision |
| | | | | determination. Any detection of |
| | | | | collision shall activate the trigger |
| } | | | | |

Example parameters of an action structure are shown in Table 4. The example action structure described below in Table 4 corresponds to FIG. 5B.

TABLE 4
Action semantic

| Name | Type | Usage | Default | Description |
|---|---|---|---|---|
| type | enum | M | ACTIVATE | Defines the type of the action by |
| | | | | taking one of the following values: |
| | | | | ACTIVATE = 0, |
| | | | | TRANSFORM = 1, |
| | | | | ANIMATE = 2, |
| | | | | CONTROL_MEDIA = 3, |
| | | | | PLACE_AT = 4, |
| | | | | MANIPULATE = 5, |
| | | | | SET_MATERIAL = 6 |
| delay | number | O | | Duration of delay in second before |
| | | | | executing the action |
| If (type == ACTIVATE){ | | | | |
| activationStatus | enum | M | ENABLED | ENABLED = 0: the node shall be |
| | | | | considered by the application |
| | | | | DISABLED = 1: the node shall not |
| | | | | be considered by the application |
| nodes | array | M | | Indices of the nodes in the nodes |
| | | | | array to set the activation status |
| } | | | | |
| If (type == TRANSFORM){ | | | | |
| transform | | M | | 4 × 4 transformation matrix to apply |
| | | | | to the nodes |
| nodes | array | M | | Indices of the nodes in the nodes |
| | | | | array to be transformed |
| } | | | | |
| If (type == ANIMATE){ | | | | |
| animation | number | M | | index of the animation in the |
| | | | | animations array to be considered |
| animationControl | enum | M | PLAY | PLAY = 0, |
| | | | | PAUSE = 1, |
| | | | | RESUME = 2, |
| | | | | STOP = 3 |
| } | | | | |
| If (type == CONTROL_MEDIA){ | | | | |
| media | number | M | | Index of the media in the MPEG |
| | | | | media array to be considered |
| mediaControl | enum | M | PLAY | PLAY = 0, |
| | | | | PAUSE = 1, |
| | | | | RESUME = 2, |
| | | | | STOP = 3 |
| } | | | | |
| If (type == PLACE_AT){ | | | | |
| placeDescription | string | M | | Describe the place position (e.g., |
| | | | | “/user/hand/left/pose”) |
| nodes | array | M | | Indices of the nodes in the nodes |
| | | | | array to be placed. |
| } | | | | |
| If (type == MANIPULATE){ | | | | |
| action | enum | M | FREE | FREE = 0: the nodes follow the |
| | | | | user pointing device and its |
| | | | | rotation, |
| | | | | FREE_FIXED_ROTATION = 1: the |
| | | | | nodes follow the user pointing |
| | | | | device but without rotation, |
| | | | | SLIDE = 2: the nodes move linearly |
| | | | | along the provided axis by |
| | | | | following the user pointing device |
| | | | | TRANSLATE = 3: the nodes |
| | | | | translate by following the user |
| | | | | pointing device, |
| | | | | ROTATE = 4: the nodes rotate |
| | | | | around the provided axis by |
| | | | | following the user pointing device, |
| | | | | SCALE = 5: performs a central |
| | | | | scaling of the nodes by following |
| | | | | the user pointing device |
| axis | array | O | | (x, y, z) coordinates of the axis used |
| | | | | for rotation and sliding. These |
| | | | | coordinates are relative to the local |
| | | | | space created by the |
| | | | | USER_INPUT trigger activation. |
| | | | | e.g., a “/user/hand/left/pose” user |
| | | | | input trigger creates a local space |
| | | | | attached to the user left hand |
| nodes | array | M | | Indices of the nodes in the nodes |
| | | | | array to be manipulated |
| } | | | | |
| If (type == SET_MATERIAL){ | | | | |
| material | number | M | | Index of the material in the |
| | | | | materials array to apply to the |
| | | | | nodes |
| nodes | array | M | | Indices of the nodes in the nodes |
| | | | | array to set their material |
| } | | | | |

Example parameters of a behavior structure are shown in Table 5. Table 5 shows a triggersControl enumeration that uses a logical OR operator to combine multiple triggers when the enumeration is 0 and uses a logical AND operator to combine multiple triggers when the enumeration is 1.

TABLE 5
First example behavior semantic

| Name | Type | Usage | Default | Description |
|---|---|---|---|---|
| triggers | array | M | | Indices of the triggers in the |
| | | | | triggers array considered for this |
| | | | | behavior |
| actions | array | M | | Indices of the actions in the actions |
| | | | | array considered for this behavior |
| triggersControl | enum | M | LOGICAL_OR | LOGICAL_OR = 0: an activation of |
| | | | | any of the defined triggers shall |
| | | | | execute the defined actions, |
| | | | | LOGICAL_AND = 1: all the defined |
| | | | | triggers shall be activated to |
| | | | | execute the defined actions |
| actionsControl | enum | M | SEQUENTIAL | Defines the way to execute the |
| | | | | defined actions. |
| | | | | SEQUENTIAL = 0: each defined |
| | | | | action is executed sequentially in |
| | | | | the order of the actions array, |
| | | | | PARALLEL = 1: the defined actions |
| | | | | are executed concurrently |
| interruptAction | number | O | | Index of the action in the actions |
| | | | | array to be executed if the behavior |
| | | | | is still on-going and is no more |
| | | | | defined in a newly received scene |
| | | | | update |
| priority | number | M | | Weight associated to the behavior. |
| | | | | Used to select a behavior when |
| | | | | several behaviors are active at |
| | | | | same time for one node |

Example parameters of an updated behavior structure, according to some embodiments, are shown in Table 6. Table 6 shows an activate enumeration that lists various activation states for how and when the various triggers need to be activated. Table 6 also shows a triggersControl string that uses a string value to indicate the logical operators to apply when combining multiple triggers. The updated example behavior structure described below in Table 6 corresponds to FIG. 5C.

TABLE 6
Second example behavior semantic

| Name | Type | Usage | Default | Description |
|---|---|---|---|---|
| triggers | array | M | | Indices of the triggers in the |
| | | | | triggers array considered for this |
| | | | | behavior |
| actions | array | M | | Indices of the actions in the actions |
| | | | | array considered for this behavior |
| activate | enum | M | ACTIVATE_FIRST_ENTER | Indicates how and when the |
| | | | | combination of triggers must be |
| | | | | activated: |
| | | | | ACTIVATE_FIRST_ENTER = 0 |
| | | | | ACTIVATE_EACH_ENTER = 1 |
| | | | | ACTIVATE_ON = 2 |
| | | | | ACTIVATE_FIRST_EXIT = 3 |
| | | | | ACTIVATE_EACH_EXIT = 4 |
| | | | | ACTIVE_OFF = 5 |
| triggersControl | string | M | (empty string) | Set of logical operations to apply to |
| | | | | the list of triggers. |
| actionsControl | enum | M | SEQUENTIAL | Defines the way to execute the |
| | | | | defined actions. |
| | | | | SEQUENTIAL = 0: each defined |
| | | | | action is executed sequentially in |
| | | | | the order of the actions array, |
| | | | | PARALLEL = 1: the defined actions |
| | | | | are executed concurrently |
| interruptAction | number | O | | Index of the action in the actions |
| | | | | array to be executed if the behavior |
| | | | | is still on-going and is no more |
| | | | | defined in a newly received scene |
| | | | | update |
| priority | number | M | | Weight associated to the behavior. |
| | | | | Used to select a behavior when |
| | | | | several behaviors are active at |
| | | | | same time for one node |

In a first example presented in FIGS. 5A to 5D, a virtual 3D object is continuously displayed and transformed during a media sequence. Once the user's left hand is detected, the virtual 3D object is placed on the user's left hand and the media sequence continuously follows the virtual 3D object.

FIG. 5A is a data structure illustrating an example set of triggers of an extended reality scene description according to some embodiments. FIG. 5A shows a data structure 502 with a header indicating that interactivity metadata belongs to the scene description. Three triggers for two behaviors of an example are described. The triggers may be listed within the behavior fields (such as the example shown in FIG. 5C). Listing them in a separate array allows a method or apparatus to use the same trigger for several behaviors. The parameters of an example trigger structure are shown in Table 3. The “activateOnce” field shown in the data structure of Table 2 is not in the data structure of Table 3 and FIG. 5A. FIG. 5A corresponds to Table 3. Returning to the example listed above, the first trigger of FIG. 5A is a time sequence of a MPEG media between 20 seconds and 40 seconds. The second trigger of FIG. 5A is a user input related to the user's left hand. The third trigger of FIG. 5A is a user input related to the user's right hand.

FIG. 5B is a data structure illustrating an example set of actions of an extended reality scene description according to some embodiments. The data structure 504 has an “actions” field that includes a description of the three actions needed to execute the two behaviors of the illustrative example. The first action to enable the object at node 0 in the node tree has the index 0 as it is the first action in the action array. The second action to place the object at node 0 on the user's left hand has the index 1, and the third action to transform the object at node 0 according, in the example, a transform matrix has the index 2. A fourth action to disable the object at node 0, with the index 3, is the interrupt action common to the two behaviors. FIG. 5B corresponds to Table 4.

FIG. 5C is a data structure illustrating an example set of behaviors of an extended reality scene description according to some embodiments. The data structure 506 has a “behaviors” field that includes a description of the two behaviors of the illustrative example. The lists of triggers and actions are indicated by the indices in the trigger array of FIG. 5A and the action array of FIG. 5B. The interrupt action of the two behaviors refers to the fourth action with an index number of 3 in the action array. The second behavior has a higher priority of 2 than the first behavior, which has a priority of 1. As the two behaviors apply to the same node 0 of the node tree, the second behavior is selected if the two behaviors are active at the same time. Example parameters of a behavior structure are shown in Table 6. The “activate” field shown in Table 6 and FIG. 5C is not in the data structure of Table 5. The “triggersControl” field shown in the data structure of Table 5 is changed in the data structure of Table 6 and FIG. 5C to be a string describing a set of logical operations to be performed on a list of triggers. FIG. 5C corresponds to Table 6. For the first behavior (with an index of 0), the triggersControl field indicates that only the first trigger is used. The trigger is active as long as the conditions are met, which means that the time sequence is between 20 and 40 seconds. When the first behavior applies, the first action (activate/enable the virtual object) and the third action (transform the virtual object) are performed. For the second behavior, the trigger conditions are met when the left hand is detected and the right hand is not detected. When the second behavior applies, the second action (place the virtual object at the user's left hand) is performed.

FIG. 5D is a data structure illustrating an example set of information of an extended reality scene description according to some embodiments. The data structure 508 has a “nodes” field that includes an example description of a node. For example, in the scene, the nodes may be named. Triggers, actions and behaviors may also have a unique id number or a unique name. So, when a scene description is updated, it is straightforward to detect whether an on-going behavior or a node belongs to the new scene description.

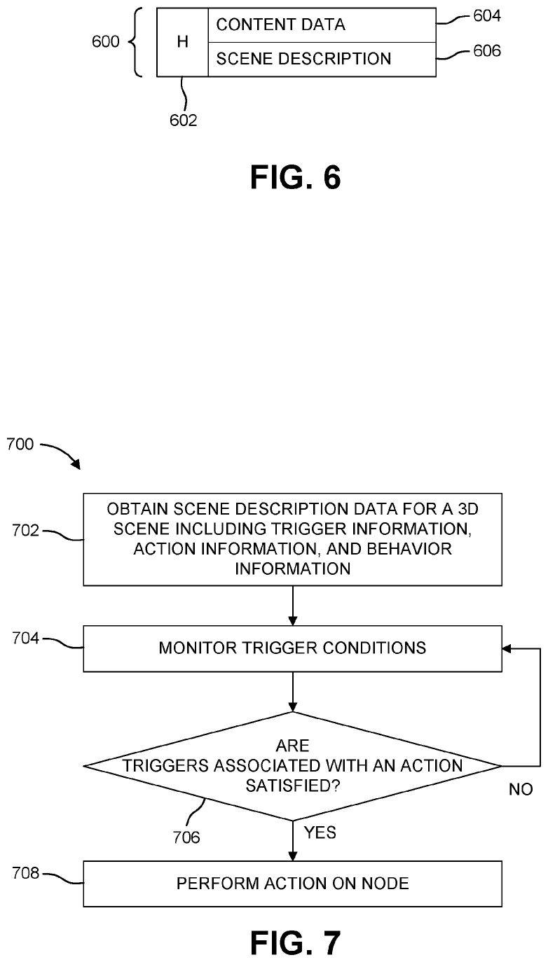

FIG. 6 is a data syntax diagram illustrating an example syntax for a data stream encoding an extended reality (XR) scene description according to some embodiments. The structure consists in a container which organizes the stream in independent elements of syntax. The structure may include a header part 602 which is a set of data common to every syntax element of the stream. For example, the header part includes some metadata about syntax elements, describing the nature and the role of each of them. The structure also includes a payload including an element of syntax 604 and an element of syntax 606. Syntax element 604 includes data representative of the media content items described in the nodes of the scene graph related to virtual elements. Images, meshes and other raw data may have been compressed according to a compression method. Element of syntax 606 is a part of the payload of the data stream and includes data encoding the scene description as described in relation to FIGS. 5A to 5D.

FIG. 7 is a flow chart illustrating a method performed according to some embodiments. scene description data is obtained for a 3D scene. The scene description data may be in GLTF format or in another format. The process 700 may include obtaining 702 scene description data that may include: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions. In some embodiments, the action is performed on a scene element that is associated with a corresponding node in a hierarchical scene description graph. Alternatively or additionally, the action may be performed on a scene element that is not associated with a particular node, such as an animation or MPEG_media element contained in the scene description.

In some embodiments, characteristics of user interactivity are monitored 704 to detect whether a trigger condition is satisfied. Monitored characteristics may include, for example, position of the user camera or viewpoint (as determined through user input and/or through sensors such as gyroscopes and accelerometers, among other possibilities), user gestures (as detected through cameras, wrist-mounted or hand-held accelerometers, or other sensors), or other user input.

In response to a determination 706 that at least one of the trigger conditions has been met and that at least a first one of the actions is associated with the trigger conditions by the behavior information, the first action is performed 708 on at least a first scene element associated with the first action.

In some embodiments, the action results in a modification to one or more scene elements in the scene description of the 3D scene. The method in some embodiments includes rendering the 3D scene according to the changed scene description. In other embodiments, a modified scene description is provided to a separate renderer for rendering the 3D scene according to conventional 3D rendering techniques. The 3D scene may be displayed on any display device, such as the display devices described herein or others. In some embodiments, the 3D scene may be displayed as an overlay together with a real-world scene using optical see-through or video see-through display. It should be noted that the display of a 3D scene as referred to herein includes displaying a 2D projection of the 3D scene using a 2D display device.

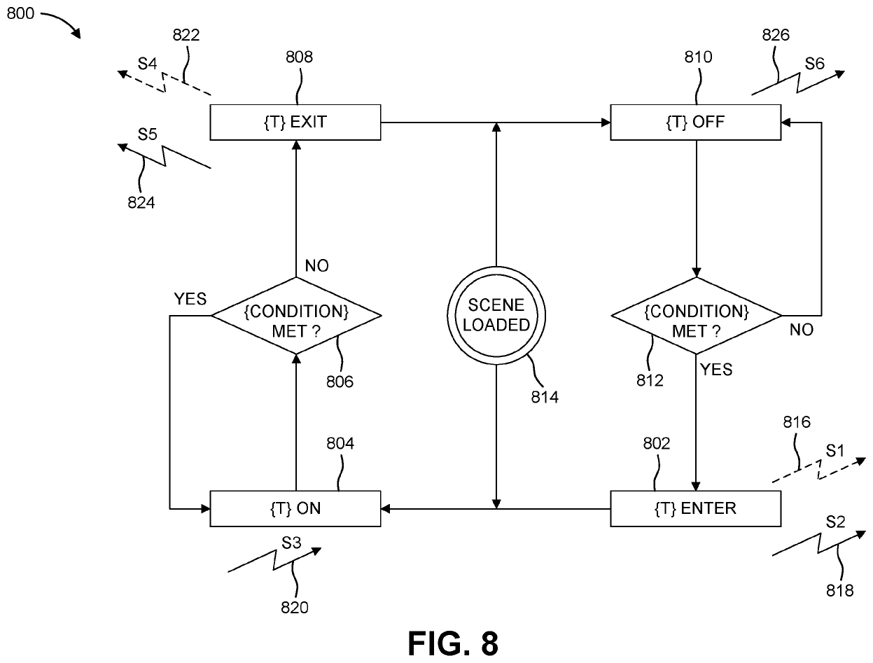

FIG. 8 is a flowchart illustrating an example process for activating a trigger or a combination of triggers according to some embodiments. During runtime, the application iterates on each defined behavior and checks the realization of the related triggers following the procedure shown in FIG. 10.

As explained above, this application, in accordance with some embodiments, defines a new activate flag at the behavior level rather than the trigger level. See Table 5. This flag specifies the activation mechanism for the combination of triggers by defining several scenarios to activate the triggers. The condition of each referenced trigger is evaluated and combined following the triggers control parameters. This control parameter allows describing combination of logical operation between referenced triggers. It may be a string that describes this combination. The result of this evaluation (met or not met) and the Activate flag tells the presentation engine when to execute the actions of that behavior. The application introduces new data in a behavior-based interactive scene description. These data fields are used by a runtime processing model to control the behavior.

The application is detailed in the scope of the MPEG-I Scene Description framework using the Khronos gITF extension mechanism (“Khronos Group”) to support additional scene description features. This application modifies the MPEG_scene_interactivity gltf extensions defined in application '024.

This modification impacts the definition of triggers (in Tables 2 and 3) and behaviors (in Tables 5 and 6):
Removal of the ActivateOnce trigger's parameter
New Activate behavior parameter.
Modification of the triggersControl parameter so that multiple operations (e.g., AND, OR, NOT, or other operators) can be used for one combination of triggers. It may be a string combining the trigger index in the triggers array and logical operations. For example:
   A ‘#’ tag to indicate the trigger index, ‘&’ to indicate a logical AND operation, ‘|’ for a logical OR operation and ‘˜’ for a NOT operation, and parenthesis to group some operations. Such a syntax may give the following string:
      “#1&˜ #2|(#3& #4)”.
The default empty string may be understood as a logical OR between all the triggers.

Returning to the discussion of FIG. 8, FIG. 8 represents the states of the combination of triggers ({T} xxxx). The combination of conditions ({Condition}) may be continuously evaluated: each condition may be evaluated, and all the evaluation results are combined following the triggersControl parameter. Depending on the state and the value of the Activate flag, the referenced actions are executed:
S1: once when conditions are first met (used when Activate=ACTIVATE_FIRST_ENTER)
S2: once each time the conditions are met (used when Activate=ACTIVATE_EACH_ENTER)
S3: as long as conditions are met (used when Activate=ACTIVATE_ON)
S4: once when conditions are no longer met for the first time (used when Activate=ACTIVATE_FIRST_EXIT).
S5: once each time the conditions are not met (used when Activate=ACTIVATE_EACH_EXIT)
S6: as long as conditions are not met (used when Activate=ACTIVATE_OFF)
   #

After the scene is loaded 814, the behaviors are loaded, and each combination of triggers is evaluated and initialized to the state {T} off 810 or state {T} on 804, and the referenced actions are executed (S6 case 826 or S3 820 case, respectively).

From the state {T} off 810, when the combination of conditions 812 is met, the triggers enter the state {T} enter 802 and the referenced actions are executed: only for the first time (S1 case 816) or each time (S2 case 818).

From the state {T} enter, the triggers automatically go to the state {T} on 804, and the referenced actions are executed (S3 case 820).

As long as the conditions 806 are met, the triggers are in the state {T} on 804 and the referenced actions are executed (S3 case 820).

From the state {T} on 804, when the conditions 806 are no longer met, the triggers enter the state {T} exit 808, and the referenced actions are executed: only for the first time (S4 case 822) or each time (S5 case 824).

From the state {T} exit, the triggers automatically go to the state {T} off 810, and the referenced actions are executed (S6 case 826).

Alternatively, S1 case 816 or S4 case 822, respectively, may be replaced by an (S1-n) case or (S4-n) case, respectively, that activates the triggers when the triggers enter the state {T} enter 802 or state {T} exit 808, respectively. for the first n times. The value of n may be specified in an additional behavior's parameter.

Alternatively, the triggers' graph may be applied out of the above behavior's mechanism. A combination of triggers may be specified for a scene, and S1 to S6 may be considered as events that are fired to execute predefined callback functions.

MPEG_scene_interactivity extensions semantics may be added to the MPEG-I SD standard.

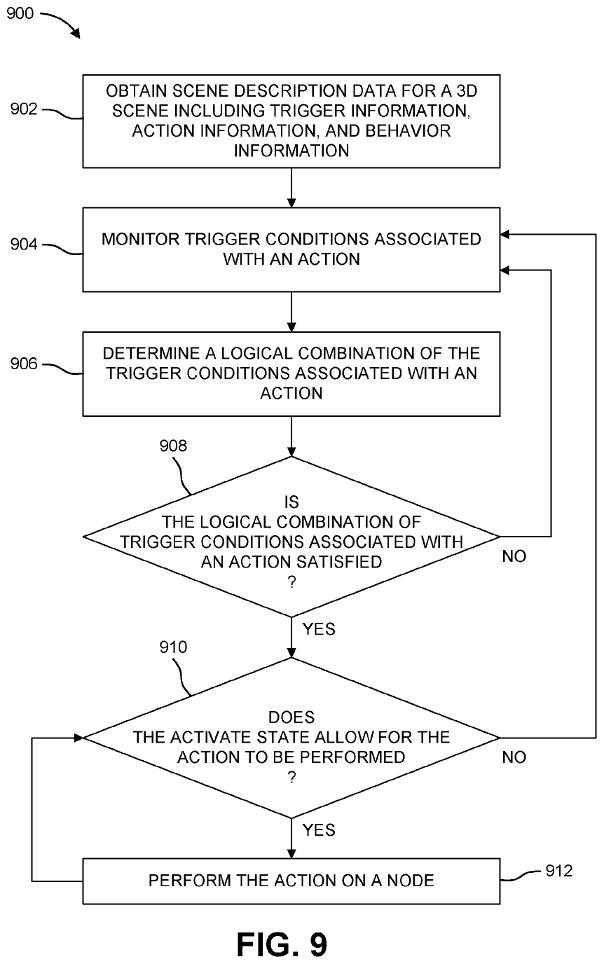

FIG. 9 is a flowchart illustrating an example process for rendering an extended reality scene for an updated trigger mechanism according to some embodiments. For some embodiments of a process 900, scene description data for a 3D scene is obtained 902. The scene description data may include trigger information, action information, and behavior information. For some embodiments, the scene description data may include data that follows one of more of the data structures shown in Tables 3, 4, and 6 and FIGS. 5A, 5B, 5C, and 5D. The method may further include monitoring 904 one or more trigger conditions associated with an action. The one or more trigger conditions associated with an action may be logically combined 906. For example, in the case of one trigger, no combination of triggers may be performed but for example a NOT operation may be performed on the trigger in accordance with some embodiments. In another example, a first trigger state may be inverted (operated on by a NOT logical operator) and the inverted first trigger may be logically OR-ed with a second trigger state. The method may then determine 908 if the logical combination of the one or more triggers produces a TRUE result. If the logical combination produces a TRUE result, then the method may determine 910 if the activate state allows for the associated action to be performed. If so, then the associated action may be performed 912 on the associated node. For example, the activate state may be ACTIVATE_EACH_ENTER. If the device performing the method is currently in the S2 state (as described in relation to FIG. 8), then the associated action may be performed each time the logical combination of the one or more triggers produces a TRUE result. If the activate state does not allow for the action to be performed, then the method may return to monitoring one or more trigger conditions associated with the action.

For some embodiments, a check may be done to determine that the logical combination has produced a result (which may be a true or false result). If a result of the logical combination is produced, then a check may be done to determine if the activate state allows for the action to be performed. If the activate state allows for the action to be performed, then the action may be performed on a node.

FIG. 10 is a flowchart illustrating an example process for a trigger activation mechanism in a time-evolving scene description according to some embodiments. For some embodiments, an example process 1000 may include obtaining 1002 scene description data for a 3D scene. For some embodiments, the scene description data may include scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions. For some embodiments, in response 1004 to a logical determination that: (i) a combination of at least one of the trigger conditions has been met and (ii) at least a first one of the actions is associated with the combination of trigger conditions by the behavior information, the example process may further include performing the first action on at least a first node associated with the first action.

While the methods and systems in accordance with some embodiments are generally discussed in context of extended reality (XR), some embodiments may be applied to any XR contexts such as, e.g., virtual reality (VR)/mixed reality (MR)/augmented reality (AR) contexts. Also, although the term “head mounted display (HMD)” is used herein in accordance with some embodiments, some embodiments may be applied to a wearable device (which may or may not be attached to the head) capable of, e.g., XR, VR, AR, and/or MR for some embodiments.

An example method in accordance with some embodiments may include: obtaining scene description data for a 3D scene, wherein the scene description data may include: scene element information describing each of a plurality of scene elements in the scene, trigger information describing at least one trigger condition, action information describing at least one action to perform on one or more scene elements associated with the action, and behavior information, wherein the behavior information may include: a list of at least one trigger, a trigger combination information, the trigger combination information indicating how the at least one trigger condition corresponding to a trigger of the list is combined with other trigger conditions corresponding to other triggers of the list, and an activate information, the activate information indicating when to perform a combination of the at least one trigger of the list with the other triggers of the list; and in response to a logical determination that: (i) the combination of a trigger condition of the at least one trigger of the list with trigger conditions of the other triggers of the list has produced a true result and (ii) the activate information indicating that the combination of the at least one trigger of the list with the other triggers of the list is to be performed, may perform a first action, of the at least one action, on one or more scene elements associated with the first action.

For some embodiments of the example method, the list may include one trigger, and there are no other triggers of the list, the trigger combination information may include a unary operator operating on the one trigger, and the activate information may indicate when to perform the unary operator on the one trigger.

For some embodiments of the example method, the list may include at least two triggers, the trigger combination information may indicate how the at least two triggers are to be combined, and the activate information may indicate when to perform the combination of the at least two triggers of the list.

For some embodiments of the example method, performing the first action may include performing the first action one or more times based on the activate information.

For some embodiments of the example method, determining the combination of the trigger condition of the at least one trigger of the list with trigger conditions of the other triggers of the list may include performing a logical operation on at least one of the trigger conditions.

For some embodiments of the example method, determining the combination of the trigger condition of the at least one trigger of the list with trigger conditions of the other triggers of the list may include performing a logical OR operation of at least two trigger conditions.

For some embodiments of the example method, at least a first one of the trigger conditions may be a visibility condition that is satisfied when a specified scene element is visible to a specified camera node.

For some embodiments of the example method, at least a first one of the trigger conditions may be a proximity condition that is satisfied when a distance from a user camera to a specified scene element is within specified bounds.

For some embodiments of the example method, at least a first one of the trigger conditions may be a user input condition that is satisfied when a specified user interaction is detected.

For some embodiments of the example method, at least a first one of the trigger conditions may be a timed condition that is satisfied during a specified time period.

For some embodiments of the example method, at least a first one of the trigger conditions may be a collider condition that is satisfied in response to detection of a collision between specified scene elements.

For some embodiments of the example method, the action information may describe at least two actions, and the behavior information may include information indicating, for at least one behavior, an order in which at least two of the at least two actions are to be performed.

For some embodiments of the example method, the action information may describe at least two actions, and the behavior information may include information indicating that at least two of the at least two actions are to be performed concurrently.

For some embodiments of the example method, at least one of the scene elements in the scene may be a virtual object.

In some embodiments, the example method may further include rendering the 3D scene according to the scene description data as operated on by the first action.

For some embodiments of the example method, the trigger information may include an array of two or more triggers in the 3D scene.

For some embodiments of the example method, the action information may include an array of two or more actions in the 3D scene.

For some embodiments of the example method, the behavior information may include an array of two or more behaviors in the 3D scene.

For some embodiments of the example method, the scene description data may be provided in a JSON format.

For some embodiments of the example method, the scene description data may be provided in a GLTF format.

A further example method in accordance with some embodiments may include: obtaining scene description data for a 3D scene, wherein the scene description data may include: scene element information describing each of a plurality of scene elements in the scene, trigger information describing at least one trigger condition, action information describing at least one action to perform on one or more scene elements associated with the action, and behavior information, wherein the behavior information may associate at least one of the trigger conditions with at least one of the actions; and in response to a logical determination that: (i) a combination of at least one of the trigger conditions has been met and (ii) at least a first one of the actions is associated with the combination of trigger conditions by the behavior information, may perform the first action on at least a first node associated with the first action.

For some embodiments of the further example method, the logical determination may further include determining that the at least one trigger is activated.

For some embodiments of the further example method, the logical determination may further include determining an activation status of a combination of the at least one trigger, and performing the first action may include performing the first action one or more times based on the combined activation status.

For some embodiments of the further example method, determining the combination of at least one trigger condition may include performing a logical operation on at least one of the trigger conditions.

For some embodiments of the further example method, determining the combination of at least one trigger condition may include performing a logical OR operation of at least two trigger conditions.

For some embodiments of the further example method, at least a first one of the trigger conditions may be a visibility condition that is satisfied when a specified scene element is visible to a specified camera node.

For some embodiments of the further example method, at least a first one of the trigger conditions may be a proximity condition that is satisfied when a distance from a user camera to a specified scene element is within specified bounds.

For some embodiments of the further example method, at least a first one of the trigger conditions may be a user input condition that is satisfied when a specified user interaction is detected.

For some embodiments of the further example method, at least a first one of the trigger conditions may be a timed condition that is satisfied during a specified time period.

For some embodiments of the further example method, at least a first one of the trigger conditions may be a collider condition that is satisfied in response to detection of a collision between specified scene elements.

For some embodiments of the further example method, the behavior information may identify at least one behavior, the behavior information for each behavior may identify at least one of the triggers and at least one of the actions.

For some embodiments of the further example method, the action information may describe at least two actions, and the behavior information may include information indicating, for at least one behavior, an order in which at least two of the at least two actions are to be performed.

For some embodiments of the further example method, the action information may describe at least two actions, and the behavior information may include information indicating that at least two of the at least two actions are to be performed concurrently.

For some embodiments of the further example method, at least one of the scene elements in the scene may be a virtual object.

In some embodiments, the further example method may further include rendering the 3D scene according to the scene description data as operated on by the first action.

For some embodiments of the further example method, the trigger information may include an array of two or more triggers in the 3D scene.

For some embodiments of the further example method, the action information may include an array of two or more actions in the 3D scene.

For some embodiments of the further example method, the behavior information may include an array of two or more behaviors in the 3D scene.

For some embodiments of the further example method, the scene description data may be provided in a JSON format.

For some embodiments of the further example method, the scene description data may be provided in a GLTF format.

Another example method for rendering an extended reality scene relative to a user in a timed environment in accordance with some embodiments may include: obtaining a description of the extended reality scene, the description may include: a scene tree linking nodes describing timed objects, virtual objects or relationships between objects; behaviors data items, a behavior data item may include: at least a trigger control parameter, a trigger control parameter being a description of conditions related to one or more triggers; an activate condition related to the trigger control parameter; at least an action, an action being a description of process to be performed by an extended reality engine on objects describes by nodes of the scene tree; and on condition that a logical combination of at least one of the triggers of the behavior data item is triggered and the activate condition related to the trigger control parameter of the behavior is met, applying actions of the behavior to associated objects.

For some embodiments of the another example method, the logical combination of at least one trigger may include a logical operation on at least one of the trigger conditions.

For some embodiments of the another example method, the logical combination of at least one triggers may include a logical OR operation of at least two trigger conditions.

Another further example method for updating, at runtime, a first description of an extended reality scene may include behavior data items with a second description of an extended reality scene in accordance with some embodiments may include: for each on-going behavior data item of the first description, if the on-going behavior data item is not applicable with the second description: processing an interrupt action if existing for the on-going application in the first description; stopping the on-going behavior; and applying the second description.

An example device for rendering an extended reality scene relative to a user in a timed environment in accordance with some embodiments may include: a memory associated with a processor configured to: obtain a description of the extended reality scene, the description may include: a scene tree linking nodes describing timed objects, virtual objects or relationships between objects; behaviors data items, a behavior data item may include: at least a trigger, a trigger being a description of conditions; a trigger being activated when its conditions are detected in the timed environment; and at least an action, an action being a description of process to be performed by an extended reality engine on objects describes by nodes of the scene tree; and on condition that triggers of a behavior data item are activated, apply actions of the behavior to associated objects.

For some embodiments of the example device, the processor may be further configured to: when a description of the extended reality scene is obtained, attributing an activation status set to false to at least one trigger of the description; when the conditions of the at least one trigger are met for the first time, setting the activation status of the trigger to true; and when the conditions of the at least one trigger are met, activating the trigger.

For some embodiments of the example device, the processor may be further configured to, when the conditions of the at least one trigger are met, if the activation status of the trigger is set to true, activate the trigger only if the description of the trigger authorizes a second activation.

A further example device for updating, at runtime, a first description of an extended reality scene including behavior data items with a second description of an extended reality scene in accordance with some embodiments may include: a memory associated with a processor configured to: for each on-going behavior data item of the first description, if the on-going behavior data item is not applicable with the second description: process an interrupt action if existing for the on-going application in the first description; stop the on-going behavior; and apply the second description.

An example apparatus in accordance with some embodiments may include: one or more processors configured to perform the method of any of the preceding claims.

An example computer-readable medium in accordance with some embodiments may include instructions for causing one or more processors to perform any of the methods listed above.

For some embodiments of the example computer-readable medium, the computer-readable medium may be a non-transitory storage medium.

An example computer program product in accordance with some embodiments may include: instructions which, when the program is executed by one or more processors, causes the one or more processors to carry out any of the methods listed above.

An example signal including scene description data for a 3D scene in accordance with some embodiments, the scene description data may include: scene element information describing each of a plurality of scene elements in the scene, trigger information describing at least one trigger condition, action information describing at least one action to perform on one or more scene elements associated with the action, and behavior information, wherein the behavior information may associate at least one of the trigger conditions with at least one of the actions.

A further example computer-readable medium including scene description data for a 3D scene in accordance with some embodiments, the scene description data may include: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions.

A first example method in accordance with some embodiments may include: obtaining scene description data for a 3D scene, wherein the scene description data may include: scene element information describing each of a plurality of scene elements in the scene, trigger information describing at least one trigger condition, action information describing at least one action to perform on one or more scene elements associated with the at least one action, and behavior information, wherein the behavior information may include: a trigger list of at least one trigger, an action list of at least the at least one action; trigger combination information, the trigger combination information indicating a combination of a first trigger condition corresponding to a first trigger of the trigger list with other trigger conditions corresponding to other triggers of the trigger list, and activate information, the activate information indicating when to perform the at least one action depending on a result of the trigger combination information; and in response to a logical determination that: (i) the combination of the first trigger condition corresponding to the first trigger of the trigger list with the other trigger conditions corresponding to the other triggers of the trigger list has produced the result and (ii) the activate information indicating that the result fires the first and other triggers, performing the at least one action on one or more scene elements associated with the at least one action.

For some embodiments of the first example method, the trigger list may include one trigger, and there are no other triggers of the trigger list, the trigger combination information may include a unary operator operating on the one trigger, and the activate information may indicate when to perform the unary operator on the one trigger.

For some embodiments of the first example method, the trigger list may include at least two triggers, the trigger combination information may indicate how the at least two trigger conditions are to be combined, and the activate information may indicate when to perform the at least one action depending on the result of the trigger combination information.

For some embodiments of the first example method, performing the first action may include performing the first action one or more times based on the activate information.

For some embodiments of the first example method, determining the combination of the trigger condition of the at least one trigger of the trigger list with trigger conditions of the other triggers of the trigger list may include performing a logical operation on at least one of the trigger conditions.

For some embodiments of the first example method, determining the combination of the trigger condition of the at least one trigger of the trigger list with trigger conditions of the other triggers of the trigger list may include performing a logical OR operation of at least two trigger conditions.

For some embodiments of the first example method, at least a first one of the trigger conditions is a visibility condition that is satisfied when a specified scene element is visible to a specified camera node.

For some embodiments of the first example method, at least a first one of the trigger conditions is a proximity condition that is satisfied when a distance from a user camera to a specified scene element is within specified bounds.

For some embodiments of the first example method, at least a first one of the trigger conditions is a user input condition that is satisfied when a specified user interaction is detected.

For some embodiments of the first example method, at least a first one of the trigger conditions is a timed condition that is satisfied during a specified time period.

For some embodiments of the first example method, at least a first one of the trigger conditions is a collider condition that is satisfied in response to detection of a collision between specified scene elements.

For some embodiments of the first example method, the action information may describe at least two actions, and the behavior information may include information indicating, for at least one behavior, an order in which at least two of the at least two actions are to be performed.

For some embodiments of the first example method, the action information may describe at least two actions, and the behavior information may include information indicating that at least two of the at least two actions are to be performed concurrently.

For some embodiments of the first example method, at least one of the scene elements in the scene is a virtual object.

Some embodiments of the first example method may further include rendering the 3D scene according to the scene description data as operated on by the first action.

For some embodiments of the first example method, the trigger information may include an array of two or more triggers in the 3D scene.

For some embodiments of the first example method, the action information may include an array of two or more actions in the 3D scene.

For some embodiments of the first example method, the behavior information may include an array of two or more behaviors in the 3D scene.

For some embodiments of the first example method, the scene description data may be provided in a JSON format.

For some embodiments of the first example method, the scene description data may be provided in a GLTF format.

A first example method/apparatus in accordance with some embodiments may include: a processor; and a non-transitory computer-readable medium storing instructions operative, when executed by the processor, to cause the apparatus to perform any one of methods shown above.

A second example method/apparatus in accordance with some embodiments may include: obtaining scene description data for a 3D scene, wherein the scene description data may include: scene element information describing each of a plurality of scene elements in the scene, trigger information describing at least one trigger condition, action information describing at least one action to perform on one or more scene elements associated with the at least one action, and behavior information, wherein the behavior information associates at least one of the trigger conditions with at least one of the actions; and in response to a logical determination that: (i) a combination of the at least one of the trigger conditions has been met and (ii) a first action of the at least one action is associated with the combination of the trigger conditions by the behavior information, performing the first action on at least a first node associated with the first action.

For some embodiments of the second example method, the logical determination may further include determining that a trigger associated with the at least one trigger condition is activated.

For some embodiments of the second example method, the logical determination may further include determining an activation status of a combination of the at least one trigger condition, and performing the first action may include performing the first action one or more times based on the activation status.

For some embodiments of the second example method, determining the combination of the at least one trigger condition may include performing a logical operation on the at least one of the trigger conditions.

For some embodiments of the second example method, determining the combination of the at least one trigger condition may include performing a logical OR operation on the at least two trigger conditions.

For some embodiments of the second example method, at least a first one of the at least one trigger condition is a visibility condition that is satisfied when a specified scene element is visible to a specified camera node.

For some embodiments of the second example method, at least a first one of the at least one trigger condition is a proximity condition that is satisfied when a distance from a user camera to a specified scene element is within specified bounds.

For some embodiments of the second example method, at least a first one of the at least one trigger condition is a user input condition that is satisfied when a specified user interaction is detected.

For some embodiments of the second example method, at least a first one of the at least one trigger condition is a timed condition that is satisfied during a specified time period.

For some embodiments of the second example method, at least a first one of the at least one trigger condition is a collider condition that is satisfied in response to detection of a collision between specified scene elements.

For some embodiments of the second example method, the behavior information may identify at least one behavior, the behavior information for each of the at least one behavior identifying a trigger associated with one of the at least one trigger condition and one of the at least one of action.

For some embodiments of the second example method, the action information may describe at least two actions, and the behavior information may include information indicating, for at least one behavior, an order in which at least two of the at least two actions are to be performed.

For some embodiments of the second example method, the action information may describe at least two actions, and the behavior information may include information indicating that at least two of the at least two actions are to be performed concurrently.

For some embodiments of the second example method, at least one of the scene elements in the scene is a virtual object.

Some embodiments of the second example method may further include rendering the 3D scene according to the scene description data as operated on by the first action.

For some embodiments of the second example method, the trigger information may include an array of two or more triggers in the 3D scene.

For some embodiments of the second example method, the action information may include an array of two or more actions in the 3D scene.

For some embodiments of the second example method, the behavior information may include an array of two or more behaviors in the 3D scene.

For some embodiments of the second example method, the scene description data may be provided in a JSON format.

For some embodiments of the second example method, the scene description data may be provided in a GLTF format.

A second example method/apparatus in accordance with some embodiments may include: a processor; and a non-transitory computer-readable medium storing instructions operative, when executed by the processor, to cause the apparatus to perform any one of the methods listed above.

A third example method, which is a method for rendering an extended reality scene relative to a user in a timed environment, in accordance with some embodiments may include: obtaining a description of the extended reality scene, the description may include: a scene tree linking nodes describing timed objects, virtual objects or relationships between objects; behaviors data items, a behavior data item may include: at least a trigger control parameter, a trigger control parameter being a description of conditions related to one or more triggers; an activate condition related to the trigger control parameter; at least an action, an action being a description of process to be performed by an extended reality engine on objects describes by nodes of the scene tree; and on condition that a logical combination of at least one of the triggers of the behavior data item is triggered and the activate condition related to the trigger control parameter of the behavior data item is met, applying actions of the behavior data item to associated objects.

For some embodiments of the third example method, the logical combination of at least one trigger may include a logical operation on at least one of the conditions related to the one or more triggers.

For some embodiments of the third example method, the logical combination of at least one triggers may include a logical OR operation of at least two conditions related to the one or more triggers.

A third example method/apparatus in accordance with some embodiments may include: a processor; and a non-transitory computer-readable medium storing instructions operative, when executed by the processor, to cause the apparatus to perform any one of the methods listed above.

A fourth example method, which is a method for updating, at runtime, a first description of an extended reality scene including behavior data items with a second description of an extended reality scene, in accordance with some embodiments may include, for each on-going behavior data item of the first description, if the on-going behavior data item is not applicable with the second description: processing an interrupt action if existing for the on-going application in the first description; stopping the on-going behavior; and applying the second description.

A fifth example apparatus, which is a device for rendering an extended reality scene relative to a user in a timed environment, in accordance with some embodiments may include a memory associated with a processor configured to: obtain a description of the extended reality scene, the description including: a scene tree linking nodes describing timed objects, virtual objects or relationships between objects; behaviors data items, a behavior data item may include: at least a trigger, a trigger being a description of conditions; a trigger being activated when its conditions are detected in the timed environment; and at least an action, an action being a description of process to be performed by an extended reality engine on objects describes by nodes of the scene tree; and on condition that triggers of a behavior data item are activated, apply actions of the behavior to associated objects.

For some embodiments of the fifth example apparatus, the processor is further configured to: when a description of the extended reality scene is obtained, attribute an activation status set to false to at least one trigger of the description; when the conditions of the at least one trigger are met for the first time, set the activation status of the trigger to true; and when the conditions of the at least one trigger are met, activate the trigger.

For some embodiments of the fifth example apparatus, the processor is further configured to, when the conditions of the at least one trigger are met, if the activation status of the trigger is set to true, activate the trigger only if the description of the trigger authorizes a second activation.

A sixth example apparatus, which a device for updating, at runtime, a first description of an extended reality scene including behavior data items with a second description of an extended reality scene, in accordance with some embodiments may include a memory associated with a processor configured to: for each on-going behavior data item of the first description, if the on-going behavior data item is not applicable with the second description: process an interrupt action if existing for the on-going application in the first description; stop the on-going behavior; and apply the second description.

A seventh example apparatus in accordance with some embodiments may include one or more processors configured to perform any one of the methods listed above.

An eighth example apparatus in accordance with some embodiments may include a computer-readable medium including instructions for causing one or more processors to perform any one of the methods listed above.

For some embodiments of the eighth example apparatus, the computer-readable medium is a non-transitory storage medium.

A tenth example apparatus in accordance with some embodiments may include a computer program product including instructions which, when the program is executed by one or more processors, causes the one or more processors to carry out any one of the methods listed above.

An eleventh example apparatus in accordance with some embodiments may include a signal including scene description data for a 3D scene, wherein the scene description data may include: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions.

A twelfth example method/apparatus in accordance with some embodiments may include a computer-readable medium including scene description data for a 3D scene, wherein the scene description data may include: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions.

A further example computer-readable medium including scene description data for a 3D scene in accordance with some embodiments, the scene description data may include: scene element information describing each of a plurality of scene elements in the scene, trigger information describing at least one trigger condition, action information describing at least one action to perform on one or more scene elements associated with the action, and behavior information, wherein the behavior information associates at least one of the trigger conditions with at least one of the actions.

This disclosure describes a variety of aspects, including tools, features, embodiments, models, approaches, etc. Many of these aspects are described with specificity and, at least to show the individual characteristics, are often described in a manner that may sound limiting. However, this is for purposes of clarity in description, and does not limit the disclosure or scope of those aspects. Indeed, all of the different aspects can be combined and interchanged to provide further aspects. Moreover, the aspects can be combined and interchanged with aspects described in earlier filings as well.

The aspects described and contemplated in this disclosure can be implemented in many different forms. While some embodiments are illustrated specifically, other embodiments are contemplated, and the discussion of particular embodiments does not limit the breadth of the implementations. At least one of the aspects generally relates to video encoding and decoding, and at least one other aspect generally relates to transmitting a bitstream generated or encoded. These and other aspects can be implemented as a method, an apparatus, a computer readable storage medium having stored thereon instructions for encoding or decoding video data according to any of the methods described, and/or a computer readable storage medium having stored thereon a bitstream generated according to any of the methods described.

In the present disclosure, the terms “reconstructed” and “decoded” may be used interchangeably, the terms “pixel” and “sample” may be used interchangeably, the terms “image,” “picture” and “frame” may be used interchangeably. Usually, but not necessarily, the term “reconstructed” is used at the encoder side while “decoded” is used at the decoder side.

The terms HDR (high dynamic range) and SDR (standard dynamic range) often convey specific values of dynamic range to those of ordinary skill in the art. However, additional embodiments are also intended in which a reference to HDR is understood to mean “higher dynamic range” and a reference to SDR is understood to mean “lower dynamic range.” Such additional embodiments are not constrained by any specific values of dynamic range that might often be associated with the terms “high dynamic range” and “standard dynamic range.”

Various methods are described herein, and each of the methods comprises one or more steps or actions for achieving the described method. Unless a specific order of steps or actions is required for proper operation of the method, the order and/or use of specific steps and/or actions may be modified or combined. Additionally, terms such as “first”, “second”, etc. may be used in various embodiments to modify an element, component, step, operation, etc., such as, for example, a “first decoding” and a “second decoding”. Use of such terms does not imply an ordering to the modified operations unless specifically required. So, in this example, the first decoding need not be performed before the second decoding, and may occur, for example, before, during, or in an overlapping time period with the second decoding.

Various numeric values may be used in the present disclosure, for example. The specific values are for example purposes and the aspects described are not limited to these specific values.

Embodiments described herein may be carried out by computer software implemented by a processor or other hardware, or by a combination of hardware and software. As a non-limiting example, the embodiments can be implemented by one or more integrated circuits. The processor can be of any type appropriate to the technical environment and can encompass one or more of microprocessors, general purpose computers, special purpose computers, and processors based on a multi-core architecture, as non-limiting examples.

Various implementations involve decoding. “Decoding”, as used in this disclosure, can encompass all or part of the processes performed, for example, on a received encoded sequence in order to produce a final output suitable for display. In various embodiments, such processes include one or more of the processes typically performed by a decoder, for example, entropy decoding, inverse quantization, inverse transformation, and differential decoding. In various embodiments, such processes also, or alternatively, include processes performed by a decoder of various implementations described in this disclosure, for example, extracting a picture from a tiled (packed) picture, determining an upsampling filter to use and then upsampling a picture, and flipping a picture back to its intended orientation.

As further examples, in one embodiment “decoding” refers only to entropy decoding, in another embodiment “decoding” refers only to differential decoding, and in another embodiment “decoding” refers to a combination of entropy decoding and differential decoding. Whether the phrase “decoding process” is intended to refer specifically to a subset of operations or generally to the broader decoding process will be clear based on the context of the specific descriptions.

Various implementations involve encoding. In an analogous way to the above discussion about “decoding”, “encoding” as used in this disclosure can encompass all or part of the processes performed, for example, on an input video sequence in order to produce an encoded bitstream. In various embodiments, such processes include one or more of the processes typically performed by an encoder, for example, partitioning, differential encoding, transformation, quantization, and entropy encoding. In various embodiments, such processes also, or alternatively, include processes performed by an encoder of various implementations described in this disclosure.

As further examples, in one embodiment “encoding” refers only to entropy encoding, in another embodiment “encoding” refers only to differential encoding, and in another embodiment “encoding” refers to a combination of differential encoding and entropy encoding. Whether the phrase “encoding process” is intended to refer specifically to a subset of operations or generally to the broader encoding process will be clear based on the context of the specific descriptions.

Various embodiments refer to rate distortion optimization. In particular, during the encoding process, the balance or trade-off between the rate and distortion is usually considered, often given the constraints of computational complexity. The rate distortion optimization is usually formulated as minimizing a rate distortion function, which is a weighted sum of the rate and of the distortion. There are different approaches to solve the rate distortion optimization problem. For example, the approaches may be based on an extensive testing of all encoding options, including all considered modes or coding parameters values, with a complete evaluation of their coding cost and related distortion of the reconstructed signal after coding and decoding. Faster approaches may also be used, to save encoding complexity, in particular with computation of an approximated distortion based on the prediction or the prediction residual signal, not the reconstructed one. A mix of these two approaches can also be used, such as by using an approximated distortion for only some of the possible encoding options, and a complete distortion for other encoding options. Other approaches only evaluate a subset of the possible encoding options. More generally, many approaches employ any of a variety of techniques to perform the optimization, but the optimization is not necessarily a complete evaluation of both the coding cost and related distortion.

When a figure is presented as a flow diagram, it should be understood that it also provides a block diagram of a corresponding apparatus. Similarly, when a figure is presented as a block diagram, it should be understood that it also provides a flow diagram of a corresponding method/process.

The implementations and aspects described herein can be implemented in, for example, a method or a process, an apparatus, a software program, a data stream, or a signal. Even if only discussed in the context of a single form of implementation (for example, discussed only as a method), the implementation of features discussed can also be implemented in other forms (for example, an apparatus or program). An apparatus can be implemented in, for example, appropriate hardware, software, and firmware. The methods can be implemented in, for example, a processor, which refers to processing devices in general, including, for example, a computer, a microprocessor, an integrated circuit, or a programmable logic device. Processors also include communication devices, such as, for example, computers, cell phones, portable/personal digital assistants (“PDAs”), and other devices that facilitate communication of information between end-users.

Reference to “one embodiment” or “an embodiment” or “one implementation” or “an implementation”, as well as other variations thereof, means that a particular feature, structure, characteristic, and so forth described in connection with the embodiment is included in at least one embodiment. Thus, the appearances of the phrase “in one embodiment” or “in an embodiment” or “in one implementation” or “in an implementation”, as well any other variations, appearing in various places throughout this disclosure are not necessarily all referring to the same embodiment.

Additionally, this disclosure may refer to “determining” various pieces of information. Determining the information can include one or more of, for example, estimating the information, calculating the information, predicting the information, or retrieving the information from memory.

Further, this disclosure may refer to “accessing” various pieces of information. Accessing the information can include one or more of, for example, receiving the information, retrieving the information (for example, from memory), storing the information, moving the information, copying the information, calculating the information, determining the information, predicting the information, or estimating the information.

Additionally, this disclosure may refer to “receiving” various pieces of information. Receiving is, as with “accessing”, intended to be a broad term. Receiving the information can include one or more of, for example, accessing the information, or retrieving the information (for example, from memory). Further, “receiving” is typically involved, in one way or another, during operations such as, for example, storing the information, processing the information, transmitting the information, moving the information, copying the information, erasing the information, calculating the information, determining the information, predicting the information, or estimating the information.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended for as many items as are listed.

Also, as used herein, the word “signal” refers to, among other things, indicating something to a corresponding decoder. For example, in certain embodiments the encoder signals a particular one of a plurality of parameters for region-based filter parameter selection for de-artifact filtering. In this way, in an embodiment the same parameter is used at both the encoder side and the decoder side. Thus, for example, an encoder can transmit (explicit signaling) a particular parameter to the decoder so that the decoder can use the same particular parameter. Conversely, if the decoder already has the particular parameter as well as others, then signaling can be used without transmitting (implicit signaling) to simply allow the decoder to know and select the particular parameter. By avoiding transmission of any actual functions, a bit savings is realized in various embodiments. It is to be appreciated that signaling can be accomplished in a variety of ways. For example, one or more syntax elements, flags, and so forth are used to signal information to a corresponding decoder in various embodiments. While the preceding relates to the verb form of the word “signal”, the word “signal” can also be used herein as a noun.

Implementations can produce a variety of signals formatted to carry information that can be, for example, stored or transmitted. The information can include, for example, instructions for performing a method, or data produced by one of the described implementations. For example, a signal can be formatted to carry the bitstream of a described embodiment. Such a signal can be formatted, for example, as an electromagnetic wave (for example, using a radio frequency portion of spectrum) or as a baseband signal. The formatting can include, for example, encoding a data stream and modulating a carrier with the encoded data stream. The information that the signal carries can be, for example, analog or digital information. The signal can be transmitted over a variety of different wired or wireless links, as is known. The signal can be stored on a processor-readable medium.

We describe a number of embodiments. Features of these embodiments can be provided alone or in any combination, across various claim categories and types. Further, embodiments can include one or more of the following features, devices, or aspects, alone or in any combination, across various claim categories and types:
A bitstream or signal that includes one or more of the described syntax elements, or variations thereof.
A bitstream or signal that includes syntax conveying information generated according to any of the embodiments described.
Creating and/or transmitting and/or receiving and/or decoding a bitstream or signal that includes one or more of the described syntax elements, or variations thereof.
Creating and/or transmitting and/or receiving and/or decoding according to any of the embodiments described.
A method, process, apparatus, medium storing instructions, medium storing data, or signal according to any of the embodiments described.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

Note that various hardware elements of one or more of the described embodiments are referred to as “modules” that carry out (i.e., perform, execute, and the like) various functions that are described herein in connection with the respective modules. As used herein, a module includes hardware (e.g., one or more processors, one or more microprocessors, one or more microcontrollers, one or more microchips, one or more application-specific integrated circuits (ASICs), one or more field programmable gate arrays (FPGAs), one or more memory devices) deemed suitable by those of skill in the relevant art for a given implementation. Each described module may also include instructions executable for carrying out the one or more functions described as being carried out by the respective module, and it is noted that those instructions could take the form of or include hardware (i.e., hardwired) instructions, firmware instructions, software instructions, and/or the like, and may be stored in any suitable non-transitory computer-readable medium or media, such as commonly referred to as RAM, ROM, etc.

Although features and elements are described above in particular combinations, one of ordinary skill in the art will appreciate that each feature or element can be used alone or in any combination with the other features and elements. In addition, the methods described herein may be implemented in a computer program, software, or firmware incorporated in a computer-readable medium for execution by a computer or processor. Examples of computer-readable storage media include, but are not limited to, a read only memory (ROM), a random access memory (RAM), a register, cache memory, semiconductor memory devices, magnetic media such as internal hard disks and removable disks, magneto-optical media, and optical media such as CD-ROM disks, and digital versatile disks (DVDs). A processor in association with software may be used to implement a radio frequency transceiver for use in a WTRU, UE, terminal, base station, RNC, or any host computer.

1. A method comprising:
obtaining scene description data for a 3D scene,
wherein the scene description data comprises:
scene element information describing each of a plurality of scene elements in the scene, trigger information describing at least one trigger condition,
action information describing at least one action to perform on one or more scene elements associated with the at least one action, and
behavior information,
wherein the behavior information comprises:
a trigger list of at least one trigger,
an action list of at least the at least one action,
trigger combination information, the trigger combination information indicating a combination of a first trigger condition corresponding to a first trigger of the trigger list with other trigger conditions corresponding to other triggers of the trigger list, and
activate information, the activate information indicating when to perform the at least one action depending on a combined result of the trigger combination information; and
in response to a logical determination that: (i) the combination of the first trigger condition corresponding to the first trigger of the trigger list with the other trigger conditions corresponding to the other triggers of the trigger list has produced the combined result and (ii) the combined result meets the condition indicated in the activate information, performing the at least one action on one or more scene elements associated with the at least one action.

2. The method of claim 1,
wherein the trigger list comprises one trigger, and there are no other triggers of the trigger list,
wherein the trigger combination information comprises a unary operator operating on the one trigger, and
wherein the activate information indicates when to perform the unary operator on the one trigger.

3. The method of claim 1,
wherein the trigger list comprises at least two triggers,
wherein the trigger combination information indicates how the at least two trigger conditions are to be combined.

4. The method of claim 1, wherein performing the at least one action comprises performing the at least one action one or more times based on the activate information.

5. The method of claim 1, further comprising performing a logical operation on the first trigger condition and the other trigger conditions to determine the logical determination.

6. The method of claim 1, wherein the logical operation comprises at least one of a logical AND operation, a logical OR operation, or a logical NOT operation.

7. The method of claim 1, wherein at least a first one of the trigger conditions is a visibility condition that is satisfied when a specified scene element is visible to a specified camera node.

8. The method of claim 1, wherein at least a first one of the trigger conditions is a proximity condition that is satisfied when a distance from a user camera to a specified scene element is within specified bounds.

9. The method of claim 1, wherein at least a first one of the trigger conditions is a user input condition that is satisfied when a specified user interaction is detected.

10. The method of claim 1, wherein at least a first one of the trigger conditions is a timed condition that is satisfied during a specified time period.

11. The method of claim 1, wherein at least a first one of the trigger conditions is a collider condition that is satisfied in response to detection of a collision between specified scene elements.

12-13. (canceled)

14. The method of claim 1, wherein at least one of the scene elements in the scene is a virtual object.

15. The method of claim 1, further comprising rendering the 3D scene according to the scene description data as operated on by the first at least one action.

16. The method of claim 1, wherein the trigger information comprises an array of two or more triggers in the 3D scene.

17. The method of claim 1, wherein the action information comprises an array of two or more actions in the 3D scene.

18. (canceled)

19. The method of claim 1, wherein the scene description data is provided in a JSON format.

20. The method of claim 1, wherein the scene description data is provided in a GLTF format.

21. An apparatus comprising:
a processor; and
a non-transitory computer-readable medium storing instructions operative, when executed by the processor, to cause the apparatus to:
obtain scene description data for a 3D scene,
wherein the scene description data comprises:
scene element information describing each of a plurality of scene elements in the scene,
trigger information describing at least one trigger condition,
action information describing at least one action to perform on one or more scene elements associated with the at least one action, and
behavior information,
wherein the behavior information comprises:
a trigger list of at least one trigger,
an action list of at least the at least one action,
trigger combination information, the trigger combination information indicating a combination of a first trigger condition corresponding to a first trigger of the trigger list with other trigger conditions corresponding to other triggers of the trigger list, and
activate information, the activate information indicating when to perform the at least one action depending on a combined result of the trigger combination information; and
in response to a logical determination that: (i) the combination of the first trigger condition corresponding to the first trigger of the trigger list with the other trigger conditions corresponding to the other triggers of the trigger list has produced the combined result and (ii) the combined result meets the condition indicated in the activate information, perform the at least one action on one or more scene elements associated with the at least one action.

22-42. (canceled)

43. A method for rendering an extended reality scene relative to a user in a timed environment, the method comprising:
obtaining a description of the extended reality scene, the description comprising:
a scene tree linking nodes describing timed objects, virtual objects or relationships between objects;
behaviors data items, a behavior data item comprising:
at least a trigger control parameter, a trigger control parameter being a description of conditions related to one or more triggers;
an activate condition related to the trigger control parameter;
at least an action, an action being a description of process to be performed by an extended reality engine on objects describes by nodes of the scene tree; and
on condition that a logical combination of at least one of the triggers of the behavior data item is triggered and the activate condition related to the trigger control parameter of the behavior data item is met, applying actions of the behavior data item to associated objects.

44-57. (canceled)

58. The method of claim 1, wherein the activate information comprises an activate flag and the condition indicated in the activate information comprises a state and a value of the activate flag.
